(19) United States
(12) Patent Application Publication
(10) Pub. No.: US 2021/0047881 A1
(43) Pub. Date: Feb. 18, 2021

(54) ROLLER SHUTTER FOR MITIGATING IMPACT FORCE

(71) Applicant: Gliderol Doors (S) Pte Ltd, Singapore (SG)

(72) Inventor: Lok Yung Wong, Singapore (SG)

(21) Appl. No.: 16/760,311

(22) PCT Filed: Jul. 25, 2019
(86) PCT No.: PCT/SG2019/050363

§ 371 Date: Apr. 29, 2020

(30) Foreign Application Priority Data
Jun. 6, 2019 (SG) 10201905150P

(51) Int. Cl. E06B 9/15

(52) U.S. Cl. CPC E06B 9/15; E06B 2009/1566; E06B 2009/1577; E06B 2009/1555

(57) ABSTRACT

A roller shutter may include a rotatable drum; a shutter curtain including a series of three or more elongate slats pivotally interlocked in a longitudinal-edge-to-longitudinal-edge arrangement and arranged parallel to the rotatable drum, wherein a first and second longitudinal end portions of each elongate slat may be respectively aligned to form a first side border and a second side border, respectively, of the shutter curtain, wherein the first and second longitudinal end portions of each elongate slat may be respectively provided with at least one eyelet-structure which protrudes therefrom, whereby a first and second rows of eyelet-structures are formed along the first and second side borders; and at least a first cord and a second cord respectively strung loosely through all eyelet-structures of respective row of eyelet-structures, and each cord may be configured to confine all eyelet-structures of the respective row of eyelet-structures within a length of each cord.

### TECHNICAL FIELD

Various embodiments generally relate to a roller shutter for mitigating an impact force.

### BACKGROUND

Roller shutter has been commonly installed at the entrance of various types of premises such as retail shops, warehouses, buildings, hangars, garages, etc. for controlling physical access into the enclosed space of the respective premises. When the shutter curtain of the roller shutter is down, it provides some form of protection against environmental factors such as wind and/or rain. It also provides certain amount of security protection against intrusion or breaking in. A typical roller shutter generally includes a plurality of horizontally extending slats connected to each other to form the shutter curtain. The shutter curtain is being wound on and/or off a drum to raise or lower the shutter curtain. Further, the shutter curtain is typically guided by guide channels along the two sides of the entrance. Such conventional roller shutter may suffice for the purpose of simple protection against wind and/or rain, or limited protection against intrusion or breaking in. However, strong wind during storm or typhoon, or an explosion or a blast which may apply a sudden impact force on the roller shutter may cause the individual slats of the shutter curtain to break into pieces and dislodge from the shutter curtain to become flying shrapnel that may cause further property damage or personnel injury.

Accordingly, there is a need for an effective roller shutter to address the above issues, for example to mitigate the sudden impact force on the roller shutter.

### SUMMARY

According to various embodiments, there is provided a roller shutter. The roller shutter may include a rotatable drum having a rotational axis. The roller shutter may include a shutter curtain including a series of three or more elongate slats pivotally interlocked in a longitudinal-edge-to-longitudinal-edge arrangement one after another and arranged parallel to the rotational axis of the rotatable drum in a manner so as to be capable of being wound on and off the rotatable drum together in an interlocked state. According to various embodiments, each of the elongate slats may have a first longitudinal end portion and a second longitudinal end portion, wherein the first and second longitudinal end portions may be respectively aligned to form a first side border and a second side border, respectively, of the shutter curtain. According to various embodiments, the first longitudinal end portion and the second longitudinal end portion of each elongate slat may be respectively provided with at least one eyelet-structure which protrudes therefrom, whereby a first row of eyelet-structures and a second row of eyelet-structures are formed along the first and second side borders, respectively, of the shutter curtain. The roller shutter may further include at least a first cord and a second cord. According to various embodiments, the first cord may be strung loosely through all eyelet-structures of the first row of eyelet-structures and the second cord may be strung loosely through all eyelet-structures of the second row of eyelet-structures. According to various embodiments, each cord may be configured to confine all eyelet-structures of respective row of eyelet-structures within a length of each cord.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a shows a roller shutter according to various embodiments;

FIG. 2A shows two pivotally interlocked elongate slats of the shutter curtain of the roller shutter of FIG. 1 with a surface of one of the elongate slats cutaway to show an interior of said elongate slat according to various embodiments;

FIG. 2B shows the two pivotally interlocked elongate slats of FIG. 2A with one of the elongate slats in an exploded view according to various embodiments;

FIG. 3A shows two pivotally interlocked elongate slats of the shutter curtain of the roller shutter of FIG. 1 with a surface of one of the elongate slats cutaway to show a variant of an interior of said elongate slat according to various embodiments;

FIG. 3B shows the two pivotally interlocked elongate slats of FIG. 3A with one of the elongate slats in an exploded view according to various embodiments;

FIG. 4A shows a cross sectional view of the shutter curtain of the roller shutter of FIG. 1 when the shutter curtain is fully lowered according to various embodiments;

FIG. 4B shows a cross sectional view of the shutter curtain of the roller shutter of FIG. 1 when the shutter curtain is partially lowered according to various embodiments;

FIG. 4C shows an enlarged view of the circled portion in FIG. 4A illustrating an retaining arrangement according to various embodiments;

FIG. 5 shows a roller shutter according to various embodiments;

FIG. 6A shows a cross sectional view of the shutter curtain of the roller shutter of FIG. 5 when the shutter curtain is fully lowered according to various embodiments;

FIG. 6B shows a shows a cross sectional view of the shutter curtain of the roller shutter of FIG. 6A when the shutter curtain is partially lowered according to various embodiments;

FIG. 6C shows an enlarged view of the circled portion in FIG. 6A illustrating a retaining arrangement according to various embodiments;

FIG. 7 shows a shows a roller shutter according to various embodiments;

FIG. 8A shows two pivotally interlocked elongate slats of the shutter curtain of the roller shutter of FIG. 7 with a surface of one of the elongate slats cutaway to show an interior of said elongate slat according to various embodiments;

FIG. 8B shows the two pivotally interlocked elongate slats of FIG. 8A with one of the elongate slats in an exploded view according to various embodiments;

FIG. 9A shows two pivotally interlocked elongate slats of the shutter curtain of the roller shutter of FIG. 7 with a surface of one of the elongate slats cutaway to show a variant of an interior of said elongate slat according to various embodiments;

FIG. 9B shows the two pivotally interlocked elongate slats of FIG. 9A with one of the elongate slats in an exploded view according to various embodiments;

FIG. 10A shows a cross sectional view of the shutter curtain of the roller shutter of FIG. 7 when the shutter curtain is fully lowered according to various embodiments;

FIG. 10B shows a cross sectional view of the shutter curtain of the roller shutter of FIG. 7 when the shutter curtain is partially lowered according to various embodiments;

FIG. 10C shows an enlarged view of the circled portion in FIG. 10A illustrating an retaining arrangement according to various embodiments;

FIG. 11 shows a roller shutter according to various embodiments;

FIG. 12A shows a cross sectional view of the shutter curtain of the roller shutter of FIG. 11 when the shutter curtain is fully lowered according to various embodiments;

FIG. 12B shows a shows a cross sectional view of the shutter curtain of the roller shutter of FIG. 12A when the shutter curtain is partially lowered according to various embodiments; and

FIG. 12C shows an enlarged view of the circled portion in FIG. 12A illustrating a retaining arrangement according to various embodiments.

### DETAILED DESCRIPTION

Embodiments described below in the context of the apparatus are analogously valid for the respective methods, and vice versa. Furthermore, it will be understood that the embodiments described below may be combined, for example, a part of one embodiment may be combined with a part of another embodiment.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

Various embodiments generally relate to a roller shutter. In particular, various embodiments generally relate to a roller shutter for resisting strong wind forces and/or for mitigating a sudden impact force of an explosion or a blast. In resisting strong wind forces and/or mitigating the sudden impact force, the roller shutter according to various embodiments may minimize breakage or fracture. Further, the roller shutter according to various embodiments may be configured such that the risk of broken or fractured slats being dislodged from the shutter curtain be minimized or eliminated. According to various embodiments, the roller shutter may be configured to prevent the slats of the shutter curtain from breaking into pieces and/or dislodging to become flying shrapnel.

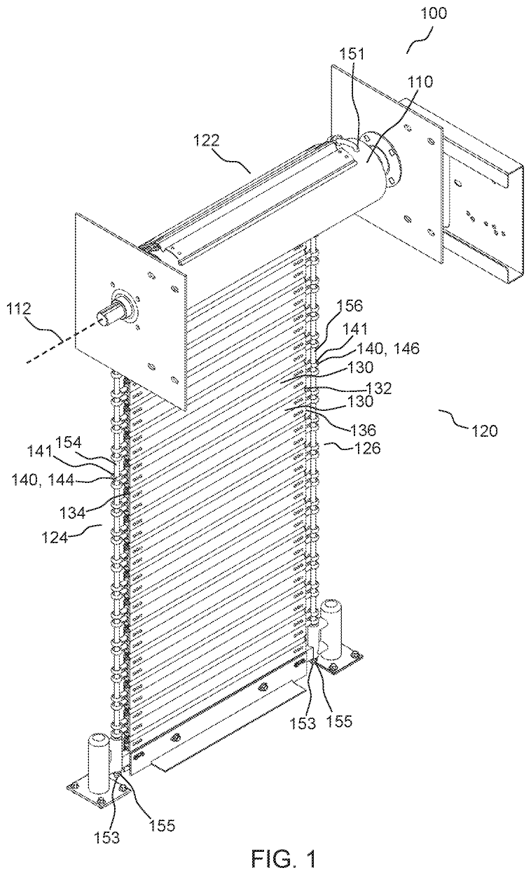

FIG. 1 shows a roller shutter 100 according to various embodiments. According to various embodiments, the roller shutter 100 may be configured for mitigating an impact force applied to the roller shutter 100. According to various embodiments, the roller shutter 100 may include a rotatable drum 110 having a rotational axis 112. According to various embodiments, the rotatable drum 110 may be of a cylindrical shape wherein an axis of the cylindrical shape may be the rotational axis 112 of the rotatable drum 110. According to various embodiments, the roller shutter 100 may include a shutter curtain 120. According to various embodiments, the shutter curtain 120 may be configured to be wound on and off the rotatable drum 110 in a manner so as to be raised or lowered for opening or closing an entrance. According to various embodiments, a lead portion 122 of the shutter curtain 120 may be coupled to the rotatable drum 110 such that rotating the drum 110 in a first rotational direction may wind the shutter curtain 120 onto the rotatable drum 110 so as to raise the shutter curtain 120, and rotating the drum 110 in a second rotational direction, which is opposite the first rotational direction, may unwind the shutter curtain 120 from the rotatable drum 110 so as to lower the shutter curtain 120.

According to various embodiments, the shutter curtain 120 may include a series of three or more elongate slats 130. Accordingly, the three or more elongate slats 130 may be arranged in sequence to form a set of three or more successive elongate slats 130. According to various embodiments, the series of three or more elongate slats 130 may be pivotally interlocked in a longitudinal-edge-to-longitudinal-edge arrangement one after another. Accordingly, the three or more elongate slats 130 may be connected or engaged in a manner in which two immediately adjacent elongate slats 130 may be connected or engaged along respective longitudinal edges 132 between the two immediately adjacent elongate slats 130 so as to be locked or attached to each other along their respective longitudinal edges 132. According to various embodiments, the two immediately adjacent elongate slats 130 may be pivotable relative to each other about a pivoting axis along a connection or an engagement between the respective longitudinal edges 132 of the two immediately adjacent elongate slats 130, and may be so connected or engaged such that the two immediately adjacent elongate slats 130 may be non-separable in a direction perpendicular to the pivoting axis.

According to various embodiments, the series of three or more elongate slats 130 may be arranged parallel to the rotational axis 112 of the rotatable drum 110. Accordingly, the shutter curtain 120 may be oriented such that each of the three or more elongate slats 120 may be extending longitudinally in a direction parallel to the rotational axis 112 of the rotatable drum 110. Hence, the longitudinal edges 132 of each elongate slat 120 may be parallel to the rotational axis 112 of the rotatable drum 110. According to various embodiments, with the series of three or more elongate slats 130 being arranged parallel to the rotational axis 112 of the rotatable drum 110, the series of three or more elongate slats 130 of the shutter curtain 120 may be wound on and off the rotatable drum 110 together in an interlocked state. Accordingly, the series of three or more elongate slats 130, which may be articulated to one another as a whole, may be wound onto the rotatable drum 110 so as to raise the shutter curtain 120 and may be unwound from the rotatable drum 110 so as to lower the shutter curtain 120.

According to various embodiments, each of the elongate slats 130 may have a first longitudinal end portion 134 and a second longitudinal end portion 136. According to various embodiments, the first and second longitudinal end portions 134, 136 of each elongate slat 130 may be respective portions at respective extremity, lengthwise, of said elongate slat 130. According to various embodiments, the first and second longitudinal end portions 134, 136 may be respectively aligned to form a first side border 124 and a second side border 126, respectively, of the shutter curtain 120. According to various embodiments, all the first longitudinal end portions 134 of the series of three or more elongate slats 130 may be aligned or brought into alignment to form a continuous line so as to form the first side border 124 of the shutter curtain 120. According to various embodiments, all the second longitudinal end portions 136 of the series of three or more elongate slats 130 may be aligned or brought into alignment to form a continuous line so as to form the second side border 126 of the shutter curtain 120.

According to various embodiments, the first longitudinal end portion 134 and the second longitudinal end portion 136 of each elongate slat 130 of the series of three or more elongate slats 130 may be respectively provided with at least one eyelet-structure 140 which protrudes therefrom. According to various embodiments, each elongate slat 130 of the series of three or more elongate slats 130 may include at least one eyelet-structure 140 protruding or jutting out from the first longitudinal end portion 134 of said elongate slat 130. According to various embodiments, each elongate slat 130 of the series of three or more elongate slats 130 may include at least one eyelet-structure 140 protruding or jutting out from the second longitudinal end portion 136 of said elongate slat 130. Accordingly, every one of the three or more elongate slats 130 may include at least one eyelet-structure 140 protruding from respective first longitudinal end portion 134 thereof and at least one eyelet-structure 140 protruding from respective second longitudinal end portion 136 thereof.

According to various embodiments, a first row 144 of eyelet-structures 140 and a second row 146 of eyelet-structures 140 may be formed along the first and second side borders 124, 126, respectively, of the shutter curtain 120. According to various embodiments, all the eyelet-structures 140 of all the first longitudinal end portions 134 of the series of three or more elongate slats 130 may be arranged or placed in succession into a line so as to make up the first row 144 of eyelet-structures 140 running alongside the first side border 124 of the shutter curtain 120. According to various embodiments, holes of all the eyelet-structures 140 of all the first longitudinal end portions 134 of the series of three or more elongate slats 130 may be in line with each other. According to various embodiments, all the eyelet-structures 140 of all the second longitudinal end portions 136 of the series of three or more elongate slats 130 may be arranged or placed in succession into a line so as to make up the second row 146 of eyelet-structures 140 running alongside the second side border 126 of the shutter curtain 120. According to various embodiments, holes of all the eyelet-structures 140 of all the second longitudinal end portions 136 of the series of three or more elongate slats 130 may be in line with each other.

According to various embodiments, the roller shutter 100 may include a first cord 154 and a second cord 156. According to various embodiments, each of the first cord 154 and the second cord 156 may include, but not limited to, a steel wire, a steel cable, or a steel cord. According to various embodiments, the first cord 154 may be strung loosely through all the eyelet-structures 140 of the first row 144 of eyelet-structures 140. Accordingly, all the eyelet-structures 140 of the first row 144 of eyelet-structures 140 may be connected by the first cord 154 which is passed through or threaded through respective eyeholes 141 of all the eyelet-structures 140 of the first row 144 of eyelet-structures 140. According to various embodiments, the second cord 156 may be strung loosely through all the eyelet-structure 140 of the second row 146 of eyelet-structures 140. Accordingly, all the eyelet-structures 140 of the second row 146 of eyelet-structures 140 may be connected by the second cord 156 which is passed through or threaded through respective eyeholes 141 of all the eyelet-structures 140 of the second row 146 of eyelet-structures 140.

According to various embodiments, each cord 154, 156 may be configured to confine all eyelet-structures 140 of respective row 144, 146 of eyelet-structures 140 within a length of each cord 154, 156. According to various embodiments, the first cord 154 may be configured to keep or retain all the eyelet-structures 140 of the first row 144 of eyelet-structures 140 within bounds or limits as defined by the length of the first cord 154. Accordingly, all the eyelet-structures 140 of the first row 144 of eyelet-structures 140 may be placed or put upon the first cord 154 in a manner so as to be non-separable from the first cord 154 and be restrained from sliding out of the first cord 154. According to various embodiments, the second cord 156 may be configured to keep or retain all the eyelet-structures 140 of the second row 146 of eyelet-structures 140 within bounds or limits as defined by the length of the second cord 156. Accordingly, all the eyelet-structures 140 of the second row 146 of eyelet-structures 140 may be placed or put upon the second cord 156 in a manner so as to be non-separable from the second cord 156 and be restrained from sliding out of the second cord 156.

According to various embodiments, as shown in FIG. 1, each cord 154, 156 may include a first cord end 151 fixedly coupled to the rotatable drum 110 and a second cord end 153 having a stopper element 155 which is configured to prevent the second cord end 153 of said cord 154, 156 from sliding out of the respective row 144, 146 of eyelet-structures 140. According to various embodiments, with the first cord end 151 of each cord 154, 156 fixedly coupled to the rotatable drum 110, the rotatable drum 110 may serve as a physical barrier to restrain or restrict or obstruct the eyelet-structures 140 from sliding out from the first cord end 151. According to various embodiments, with the stopper element 155 at the second cord end 153 of each cord 154, 156, the stopper element 155 may serve as a physical barrier to restrain or restrict or obstruct the eyelet-structures 140 from sliding out from the second cord end 153. According to various embodiments, the stopper element 155 may include, but not limited to, a crimp end, a cord end cap, a knotted end, a bulged end, or an expanded end.

According to various embodiments, not shown, each cord may include a first cord end having a first stopper element which is configured to prevent the first cord end of said cord from sliding out of the respective row of eyelet-structures, and a second cord end having a second stopper element which is configured to prevent the second cord end of said cord from sliding out of the respective row of eyelet-structures. According to various embodiments, with the first stopper element and the second stopper element respectively disposed at the first cord end and the second cord end, respectively, of said cord, the first stopper element at the first cord end may serve as a physical barrier to restrain or restrict or obstruct the eyelet-structures from sliding out from the first cord end and the second stopper element at the second cord end may serve as a physical barrier to restrain or restrict or obstruct the eyelet-structures from sliding out from the second cord end. According to various embodiments, the first stopper element and the second stopper element each may include, but not limited to, a crimp end, a cord end cap, a knotted end, a bulged end, or an expanded end.

According to various embodiments, the first cord 154 and the second cord 156 may respectively cooperate with the first row 144 of eyelet-structures 140 and the second row 146 of eyelet-structures 140 in a manner so as to collectively provide additional securing points and/or holding points for the respective elongate slats such that the respective elongate slats 130 may be retained or held even if the respective elongate slats 130 are broken or fracture from an impact force. According to various embodiments, the first cord 154 and the second cord 156 together with the first row 144 of eyelet-structures 140 and the second row 146 of eyelet-structures 140 may be an assemblage of interacting and/or interdependent features forming a unified whole system for mitigating an impact force.

According to various embodiments, the at least one eyelet-structure 140 of each longitudinal end portion 134, 136 of each elongate slat 130 may be protruding in a longitudinal direction of said elongate slat 130. Accordingly, each elongate slat 130 of the series of three or more elongate slats may include at least one eyelet-structure 140 protruding from the first longitudinal end portion 134 thereof in a direction of a length of said elongate slat 130 and at least one eyelet-structure 140 protruding from the second longitudinal end portion 134 thereof in the direction of the length of said elongate slat 130. According to various embodiments, the at least one eyelet-structure 140 of each longitudinal end portion 134, 136 of each elongate slat 130 may be oriented with an axis of a hole of the at least one eyelet-structure 140 of each longitudinal end portion 134, 136 of each elongate slat 130 in a direction parallel to a breadth of said elongate slat 130. Accordingly, the axis of the hole of the at least one eyelet-structure 140 of each longitudinal end portion 134, 136 of each elongate slat 130 may be parallel to a perpendicular direction extending between two longitudinal edges of said elongate slat 130.

According to various embodiments, as shown in FIG. 1, each of the elongate slats 130 may include two eyelet-structures 140 protruding from each longitudinal end portion 134, 136 of said elongate slat 130. According to various embodiments, the first longitudinal end portion 134 of each elongate slat 130 may include two eyelet-structures 140 protruding therefrom, and the second longitudinal end portion 136 of each elongate slat 130 may include two eyelet-structures 140 protruding therefrom.

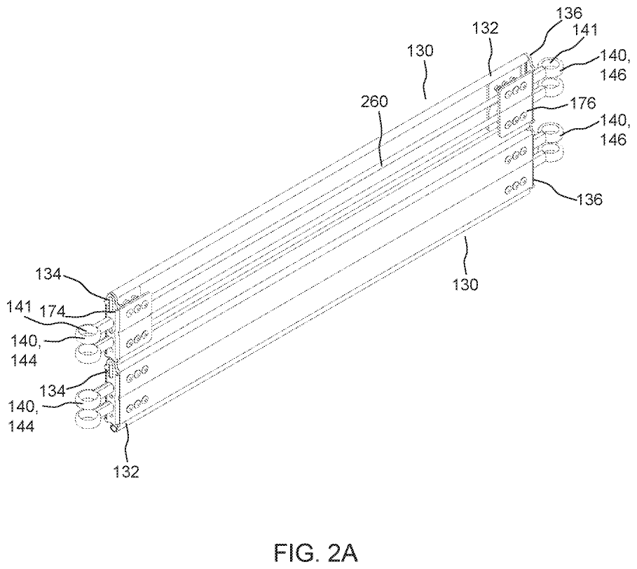

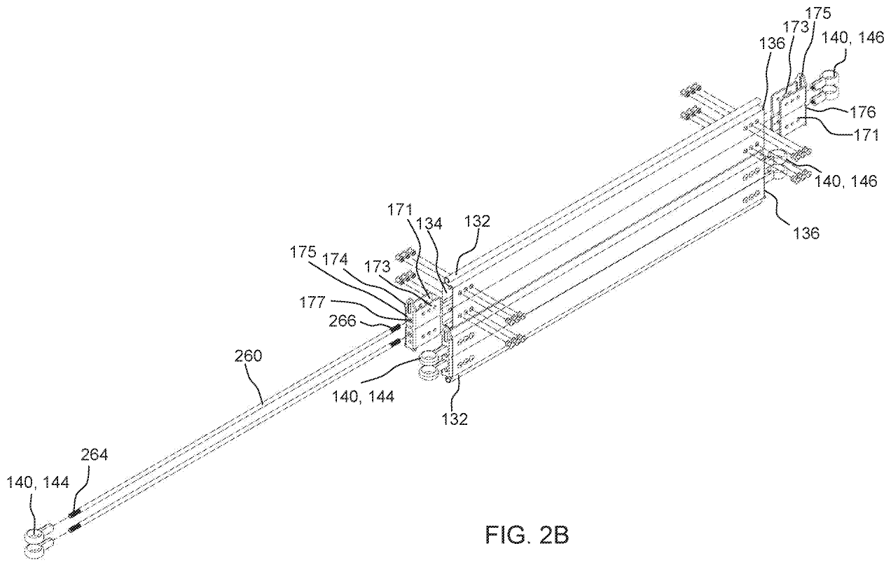

FIG. 2A shows two pivotally interlocked elongate slats 130 of the shutter curtain 120 of the roller shutter 100 of FIG. 1 with a surface of one of the elongate slats 130 cutaway to show an interior of said elongate slat 130 according to various embodiments. FIG. 2B shows the two pivotally interlocked elongate slats 130 of FIG. 2A with one of the elongate slats 130 in an exploded view according to various embodiments.

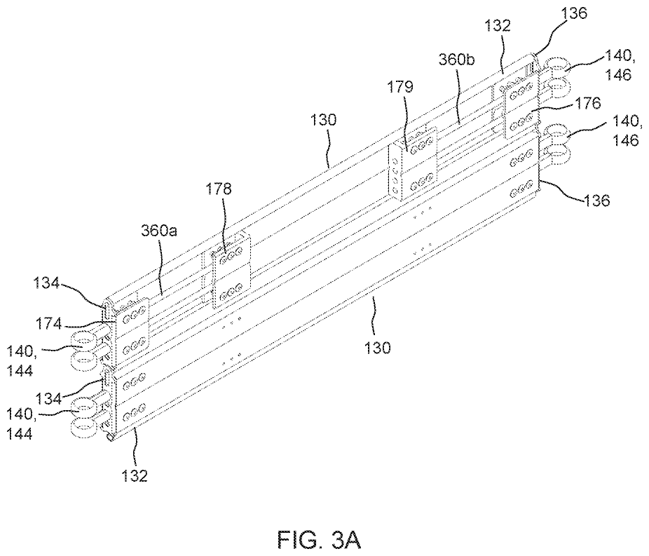

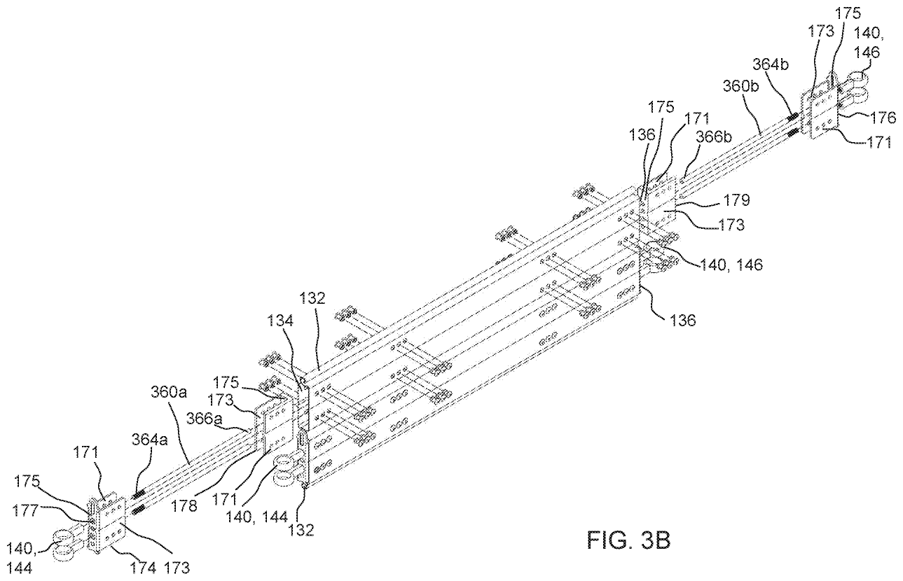

According to various embodiments, the roller shutter 100 may further include a plurality of elongate reinforcing members 260, 360a, 360b (see FIG. 3A and FIG. 3B). According to various embodiments, each of the plurality of elongate reinforcing members 260, 360a, 360b may include, but not limited to, a rod, a pole, a bar, a tube, a wire, a cable, or a cord. According to various embodiments, each of the elongate slats 130 may include at least one elongate reinforcing member 260, 360a, 360b extending within said elongate slat 130 in a manner so as to be aligned longitudinally to said elongate slat 130. According to various embodiments, the at least one elongate reinforcing member 260, 360a, 360b of each elongate slat 130 may be enclosed inside said elongate slat 130 and may be oriented lengthwise with respect to said elongate slat 130 so as to be parallel to the longitudinal direction of said elongate slat 130. According to various embodiments, the at least one elongate reinforcing member 260, 360a, 360b of each elongate slat 130 may be secured or coupled to said elongate slat 130 in a manner so as to strengthen or toughen said elongate slat 130. Accordingly, the at least one elongate reinforcing member 260, 360a, 360b of each elongate slat 130 may serve to support said elongate slat 130 to enhance its resistance against an impact force and/or to mitigate the impact force.

According to various embodiments, as shown in FIG. 2A and FIG. 2B, the at least one elongate reinforcing member 260 of at least one elongate slat 130 may extend across an entire length of said elongate slat 130. Accordingly, the at least one elongate reinforcing member 260 may span across a full length of the at least one elongate slat 130. Hence, a first longitudinal end 264 of the at least one elongate reinforcing member 260 may be joined to the first longitudinal end portion 134 of the at least one elongate slat 130 and a second longitudinal end 266 of the at least one elongate reinforcing member 260 may be joined to the second longitudinal end portion 136 of the at least one elongate slat 130. According to various embodiments, the first longitudinal end 264 of the at least one elongate reinforcing member 260 may be fixedly coupled to the first longitudinal end portion 134 of the at least one elongate slat 130 and the second longitudinal end 266 of the at least one elongate reinforcing member 260 may be fixedly coupled to the second longitudinal end portion 136 of the at least one elongate slat 130.

According to various embodiments, as shown in FIG. 2A and FIG. 2B, the at least one eyelet-structure 140 of each longitudinal end portion 134, 136 of the at least one elongate slat 130 may be integral with the at least one reinforcing member 260 extending within the at least one elongate slat 130. According to various embodiments, the at least one eyelet-structure 140 of the first longitudinal end portion 134 of the at least one elongate slat 130 may be integrally connected to the first longitudinal end 264 of the at least one elongate reinforcing member 260 and the at least one eyelet-structure 140 of the second longitudinal end portion 136 of the at least one elongate slat 130 may be integrally connected to the second longitudinal end 266 of the at least one elongate reinforcing member 260. Accordingly, the at least one eyelet-structure 140 of the first longitudinal end portion 134 of the at least one elongate slat 130, the at least one eyelet-structure 140 of the second longitudinal end portion 136 of the at least one elongate slat 130, and the at least one elongate reinforcing member 260 may be integrated or joined in such a way as to form a single unit which may serve to provide additional securing points and/or holding points for the at least one elongate slat 130 and to strengthen the at least one elongate slat 130 to enhance resistance against an impact force and/or to mitigate the impact force.

According to various embodiments, as shown in FIG. 2A and FIG. 2B, the at least one elongate slat 130 may include a first longitudinal end cover 174 and a second longitudinal end cover 176. According to various embodiments, the first longitudinal end cover 174 may be fixedly coupled to the first longitudinal end portion 134 of the at least one elongate slat 130, and the second longitudinal end cover 176 may be fixedly coupled to the second longitudinal end portion 136 of the at least one elongate slat 130. According to various embodiments, the first longitudinal end cover 174 and the second longitudinal end cover 176 each may be a U-shaped bracket having a pair of parallel wall portions 171, 173 and a interconnecting base portion 175. According to various embodiments, the first longitudinal end cover 174 and the second longitudinal end cover 176 may respectively be coupled to the first and second longitudinal end portions 134, 136 with respective pair of parallel wall portions 171, 173 thereof fixed to respective main inner walls of the at least one elongate slat 130. According to various embodiments, the respective pair of parallel wall portions 171, 173 may be fixed to respective main inner walls of the at least one elongate slat 130 via at least one fastener including, but not limited to, a rivet, a screw and a nut pair, or a bolt and a nut pair. According to various embodiments, the respective pair of parallel wall portions 171, 173 may be fixed to respective main inner walls of the at least one elongate slat 130 via three fasteners arranged in a row directed in the longitudinal direction of the at least one elongate slat 130.

According to various embodiments, the interconnecting base portion 175 of the first and second longitudinal end portions 134, 136 may include at least one hole 177. According to various embodiments, the at least one reinforcing member 260 may be inserted through the at least one hole 177 of the interconnecting base portion 175 so as to be extending within the at least one elongate slat 130. According to various embodiments, the at least one eyelet-structure 140 at the first longitudinal end portion 134 of the at least one elongate slat 130 may then be fastened or bond to the first longitudinal end 264 of the at least one elongate reinforcing member 260 and the at least one eyelet-structure 140 at the second longitudinal end portion 136 of the at least one elongate slat 130 may then be fastened or bond to the second longitudinal end 266 of the at least one elongate reinforcing member 260. Accordingly, in this manner, the first longitudinal end 264 of the at least one elongate reinforcing member 260 may be joined to the first longitudinal end portion 134 of the at least one elongate slat 130 via the the first longitudinal end cover 174 and the at least one eyelet-structure 140 at the first longitudinal end portion 134, and the second longitudinal end 266 of the at least one elongate reinforcing member 260 may be joined to the second longitudinal end portion 136 of the at least one elongate slat 130 via the second longitudinal end cover 176 and the at least one eyelet-structure 140 at the second longitudinal end portion 136.

According to various embodiments, as shown in FIG. 2A and FIG. 2B, the at least one elongate reinforcing member 260 of the at least one elongate slat 130 may include two identical elongate reinforcing member 260, each may extend across an entire length of said elongate slat 130. According to various embodiments, the two identical elongate reinforcing member 260 may be joined to the at least one elongate slat 130 in the same manner.

FIG. 3A shows two pivotally interlocked elongate slats 130 of the shutter curtain 120 of the roller shutter 100 of FIG. 1 with a surface of one of the elongate slats 130 cutaway to show a variant of an interior of said elongate slat 130 according to various embodiments. FIG. 3B shows the two pivotally interlocked elongate slats 130 of FIG. 3A with one of the elongate slats 130 in an exploded view according to various embodiments.

According to various embodiments, as shown in FIG. 3A and FIG. 3B, the at least one elongate slat 130 may include a first elongate reinforcing member 360a and a second elongate reinforcing member 360b. According to various embodiments, the first elongate reinforcing member 360a may extend longitudinally inwards from the first longitudinal end portion 134 of the at least one elongate slat 130 and the second elongate reinforcing member 360b may extend longitudinally inwards from the second longitudinal end portion 136 of the at least one elongate slat 130. According to various embodiments, the first elongate reinforcing member 360a may extend longitudinally inwards for more than a tenth of a length, or a fifth of a length, or a quarter of a length of the at least one elongate slat 130 and the second elongate reinforcing member 360b may extend longitudinally inwards for more than a tenth of a length, or a fifth of a length, or a quarter of a length of the at least one elongate slat 130. Accordingly, the first elongate reinforcing member 360a may have a span of more than a tenth, or a fifth, or a quarter of the length of the at least one elongate slat 130 and a first longitudinal end 364a of the first elongate reinforcing member 360a may be joined to the first longitudinal end portion 134 of the at least one elongate slat 130 in a manner such that the first elongate reinforcing member 360a may be directed longitudinally inward, and the second elongate reinforcing member 360b may have a span of more than a tenth, or a fifth, or a quarter of the length of the at least one elongate slat 130 and a first longitudinal end 364b of the second elongate reinforcing member 360b may be joined to the second longitudinal end portion 136 of the at least one elongate slat 130 in a manner such that the second elongate reinforcing member 360b is directed longitudinally inward. According to various embodiments, a second longitudinal end 366a of the first elongate reinforcing member 360a may be joined to the at least one elongate slat 130 and a second longitudinal end 366b of the second elongate reinforcing member 360b may be joined to the at least one elongate slat 130. According to various embodiments, the first elongate reinforcing member 360a may be fixedly coupled to the at least one elongate slat 130 and the second elongate reinforcing member 360b may be fixedly coupled to the at least one elongate slat 130.

According to various embodiments, as shown in FIG. 3A and FIG. 3B, the at least one eyelet-structure 140 of the first longitudinal end portion 134 of the at least one elongate slat 130 may be integral with the first elongate reinforcing member 360a, and the at least one eyelet-structure 140 of the second longitudinal end portion 136 of the at least one elongate slat 130 may be integral with the second elongate reinforcing member 360b. According to various embodiments, the at least one eyelet-structure 140 of the first longitudinal end portion 134 of the at least one elongate slat 130 may be integrally connected to the first longitudinal end 364a of the first elongate reinforcing member 360a and the at least one eyelet-structure 140 of the second longitudinal end portion 136 of the at least one elongate slat 130 may be integrally connected to the first longitudinal end 364b of the second elongate reinforcing member 360b. Accordingly, the at least one eyelet-structure 140 of the first longitudinal end portion 134 of the at least one elongate slat 130 and the first elongate reinforcing member 360a may be integrated or joined in such a way as to form a first single unit, and the at least one eyelet-structure 140 of the second longitudinal end portion 136 of the at least one elongate slat 130 and the second elongate reinforcing member 360b may be integrated or joined in such a way as to form a second single unit. According to various embodiments, the first single unit and the second single unit may cooperatively serve to provide additional securing points and/or holding points for the at least one elongate slat 130 and to strengthen the at least one elongate slat 130 to enhance resistance against an impact force and/or to mitigate the impact force.

According to various embodiments, as shown in FIG. 3A and FIG. 3B, the at least one elongate slat 130 may include a first longitudinal end cover 174 and a second longitudinal end cover 176. Further, the at least one elongate slat 130 may include a first intermediate bracket 178 and a second intermediate bracket 179. According to various embodiments, the first longitudinal end cover 174 may be fixedly coupled to the first longitudinal end portion 134 of the at least one elongate slat 130, and the second longitudinal end cover 176 may be fixedly coupled to the second longitudinal end portion 136 of the at least one elongate slat 130. According to various embodiments, the first intermediate bracket 178 and the second intermediate bracket 179 each may be inserted inside the at least one elongate slat 130 and may be fixedly coupled to a predetermined position inside the at least one elongate slat 130. According to various embodiments, the first intermediate bracket 178 may be positioned at a predetermined distance from the first longitudinal end cover 174 and the second intermediate bracket 179 may be positioned at a predetermined distance from the second longitudinal end cover 176. According to various embodiments, the first longitudinal end cover 174, the second longitudinal end cover 176, the first intermediate bracket 178, and the second intermediate bracket 179 each may be a U-shaped bracket having a pair of parallel wall portions 171, 173 and a interconnecting base portion 175. According to various embodiments, the first longitudinal end cover 174 and the second longitudinal end cover 176 may respectively be coupled to the first and second longitudinal end portions 134, 136 with respective pair of parallel wall portions 171, 173 thereof fixed to respective main inner walls of the at least one elongate slat 130. According to various embodiments, the first intermediate bracket 178 and the second intermediate bracket 179 may also be coupled to the at least one elongate slat 130 with respective pair of parallel wall portions 171, 173 thereof fixed to respective main inner walls of the at least one elongate slat 130. According to various embodiments, the respective pair of parallel wall portions 171, 173 may be fixed to respective main inner walls of the at least one elongate slat 130 via at least one fastener including, but not limited to, a rivet, a screw and a nut pair, or a bolt and a nut pair. According to various embodiments, the respective pair of parallel wall portions 171, 173 may be fixed to respective main inner walls of the at least one elongate slat 130 via three fasteners arranged in a row directed in the longitudinal direction of the at least one elongate slat 130.

According to various embodiments, the interconnecting base portion 175 of the first and second longitudinal end portions 134, 136 as well as the first and second intermediate brackets 178, 179 may include at least one hole 177. According to various embodiments, the first reinforcing member 360a may be inserted through the at least one hole 177 of the interconnecting base portion 175 of the first longitudinal end cover 174 so as to be extending longitudinally inwards from the first longitudinal end portion 134 of the at least one elongate slat 130. According to various embodiments, the second reinforcing member 360b may be inserted through the at least one hole 177 of the interconnecting base portion 175 of the second longitudinal end cover 176 so as to be extending longitudinally inwards from the second longitudinal end portion 136 of the at least one elongate slat 130. According to various embodiments, the at least one eyelet-structure 140 at the first longitudinal end portion 134 of the at least one elongate slat 130 may then be fastened or bond to the first longitudinal end 364a of the first elongate reinforcing member 360a and the at least one eyelet-structure 140 at the second longitudinal end portion 136 of the at least one elongate slat 130 may then be fastened or bond to the first longitudinal end 364b of the second elongate reinforcing member 360b. According to various embodiments, the second longitudinal end 366a of the first elongate reinforcing member 360a may be fastened or bonded to the at least one hole 177 of the interconnecting base portion 175 of the first intermediate bracket 178, and the second longitudinal end 366b of the second elongate reinforcing member 360b may be fastened or bonded to the at least one hole 177 of the interconnecting base portion 175 of the second intermediate bracket 179. Accordingly, in this manner, the first elongate reinforcing member 360a may be joined to the at least one elongate slat 130 via the the first longitudinal end cover 174, the at least one eyelet-structure 140 at the first longitudinal end portion 134 and the first intermediate bracket 178. Further, the second elongate reinforcing member 360b may be joined to the at least one elongate slat 130 via the the second longitudinal end cover 176, the at least one eyelet-structure 140 at the second longitudinal end portion 136 and the second intermediate bracket 179.

According to various embodiments, as shown in FIG. 3A and FIG. 3B, the at least one elongate slat 130 may include two identical pairs of the first and second elongate reinforcing members 360a, 360b. According to various embodiments, the two identical pairs of the first and second elongate reinforcing members 360a, 360b may be joined to the at least one elongate slat 130 in the same manner.

According to various embodiments, each of the elongate slats 130 of the shutter curtain 120 of the roller shutter 100 may include the at least one elongate reinforcing member 260 of FIG. 2A and FIG. 2B which extends across an entire length of said elongate slat 130. According to various embodiments, each of the elongate slats 130 of the shutter curtain 120 of the roller shutter 100 may include the first and second elongate reinforcing members 360a, 360b of FIG. 3A and FIG. 3B. According to various embodiments, the series of three of more elongate slats 130 of the shutter curtain 120 of the roller shutter 100 may include at least one elongate slat 130 having the at least one elongate reinforcing member 260 of FIG. 2A and FIG. 2B which extends across an entire length of said elongate slat 130 and at least one elongate slat 130 having the first and the second elongate reinforcing members 360a, 360b of FIG. 3A and FIG. 3B.

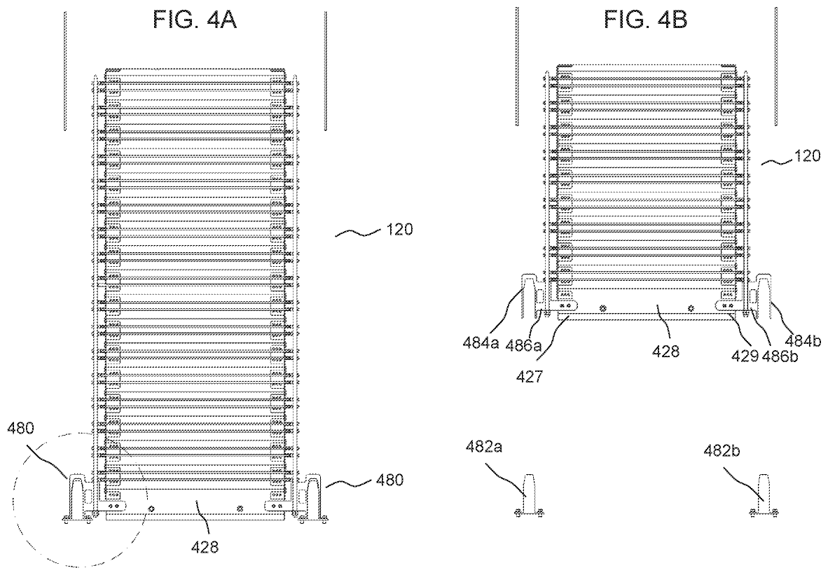

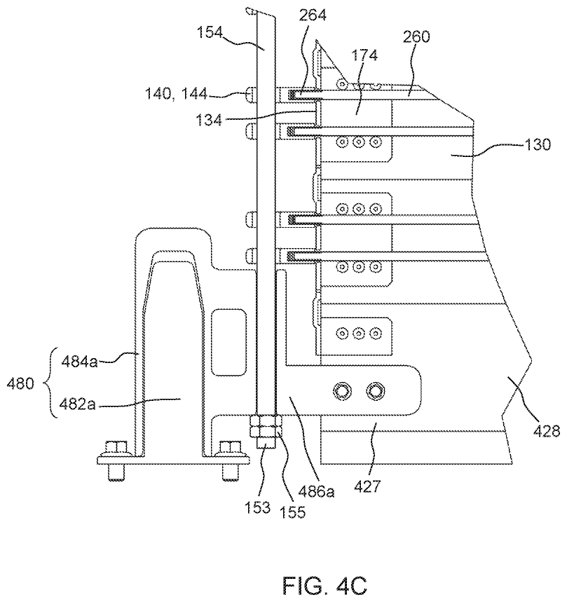

FIG. 4A shows a cross sectional view of the shutter curtain 120 of the roller shutter 100 of FIG. 1 when the shutter curtain 120 is fully lowered according to various embodiments. FIG. 4B shows a cross sectional view of the shutter curtain 120 of the roller shutter 100 of FIG. 1 when the shutter curtain 120 is partially lowered according to various embodiments. FIG. 4C shows an enlarged view of the circled portion in FIG. 4A illustrating a retaining arrangement 480 (or a retaining-and-alignment arrangement) of the roller shutter 100 according to various embodiments.

According to various embodiments, the roller shutter 100 may further include the retaining arrangement 480 (or the retaining-and-alignment arrangement) configured to align a bottom rail 428 of the shutter curtain 120 to a predetermined position on a ground and to retain or restrain the bottom rail 428 from sideways or lateral movements in said position when the shutter curtain 120 is lowered. According to various embodiments, the retaining arrangement 480 may be configured such that the bottom rail 428 of the shutter curtain 120 may be brought into alignment with the predetermined position on the ground as the shutter curtain 120 is being lowered. Further, the retaining arrangement 480 may be configured such that the bottom rail 428 may not be easily moved out of alignment (or moved sideways or moved laterally) or may be held in place with respect to horizontal movement once the shutter curtain 120 is fully lowered. Accordingly, the retaining arrangement 480 may be configured for laterally retaining the bottom rail 428 against sideways, or horizontal, or lateral movements.

According to various embodiments, the retaining arrangement 480 may include two bollards 482a, 482b fixed to the ground and two corresponding caps 484a, 484b attached to the bottom rail 428 of the shutter curtain 120. According to various embodiments, as the two corresponding caps 484a, 484b fit over the two bollards 482a, 482b when the shutter curtain 120 is lowering, the bottom rail 428 of the shutter curtain 120 may be adjusted according to a straight line joining the two bollards 482a, 482b. According to various embodiments, each of the two bollards 482a, 482b may include, but not limited to, a conical bollard or a frusto-conical bollard. According to various embodiments, each of the two bollards 482a, 482b may have a height higher than a height of the bottom rail 428 of the shutter curtain 120. According to various embodiments, each of the two corresponding caps 484a, 484b may include a cavity with a shape that correspond to the shape of the bollard 482a, 482b which the corresponding cap 484a, 484b is to be fitted on. According to various embodiments, the two bollards 482a, 482b may be fixed to the ground in a spaced apart manner such that, when the shutter curtain is lowered, a first bollard 482a may be adjacent a first longitudinal end 427 of the bottom rail 428 of the shutter curtain 120 and a second bollard 482b may be adjacent to a second longitudinal end 429 of the bottom rail 428 of the shutter curtain 120. Accordingly, the first cap 484a may be attached, via a first connecting portion 486a, to the first longitudinal end 427 of the bottom rail 428 of the shutter curtain 120 and the second cap 484b may be attached, via a second connecting portion 486b, to the second longitudinal end 429 of the bottom rail 428 of the shutter curtain 120.

According to various embodiments, the second cord end 153 of the respective cords 154, 156 may be threaded through the first and second connecting portions 486a, 486b respectively. According to various embodiments, the stopper element 155 of the second cord end 153 of the respective cords 154, 156 may be configured to retain or confine the bottom rail 428 within the length of the respective cords 154,156. According to various embodiments, the stopper element 155 of the second cord end 153 of the respective cords 154, 156 may serve as a physical barrier to restrain or restrict or obstruct the respective first and second connecting portions 486a, 486b from sliding out from the second cord end 153 of the respective cords 154, 156. With the second cord end 153 of the respective cords 154, 156 being coupled to the bottom rail 428 and the first and second cap 484a, 484b via the respective first and second connecting portion 486a, 486b, the second cord end 153 of the respective cords 154, 156 may be restrained by the retaining arrangement 480 from sideways or lateral movements due to the bottom rail 428 being restrained or retained by the retaining arrangement 480 when the shutter curtain 120 is lowered. According to various embodiments, with the first and second cords 154, 156 extending from the rotatable drum 110 to the bottom rail 428, all the slats 130 of the shutter curtain 120 (including the bottom rail 428) may be confined within the length of the respective cords 154, 156. Accordingly, when the shutter curtain 120 is lowered, the shutter curtain 120 may weigh down the second cord end 153 of the respective cords 154, 156 to the ground. Hence, the respective cords 154, 156 may be extending from the rotatable drum 110 to the ground such that the respective cords 154, 156 may provide additional support to the shutter curtain 120 in a manner so as to mitigate impact force applied on the shutter curtain 120.

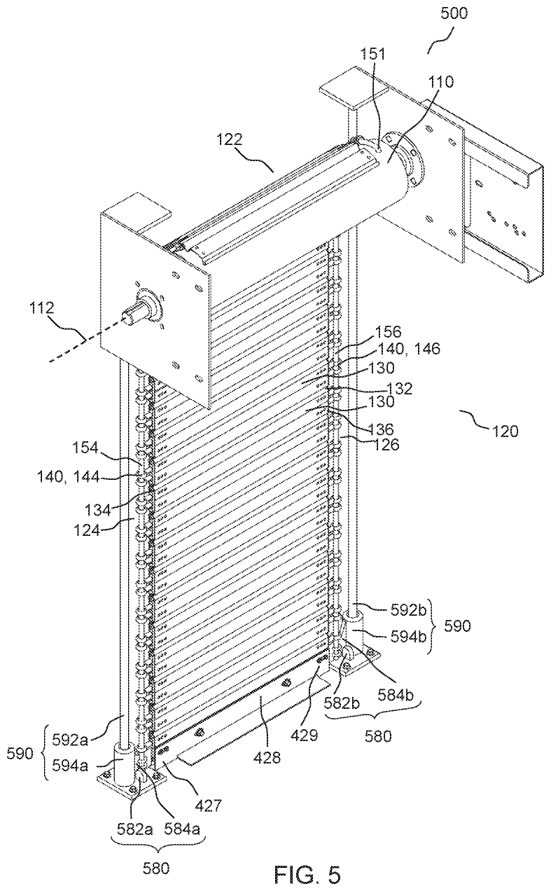

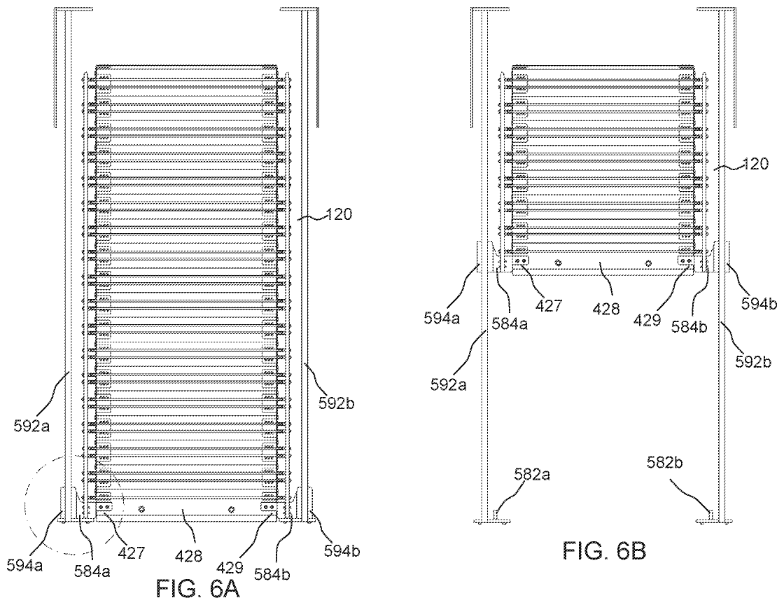

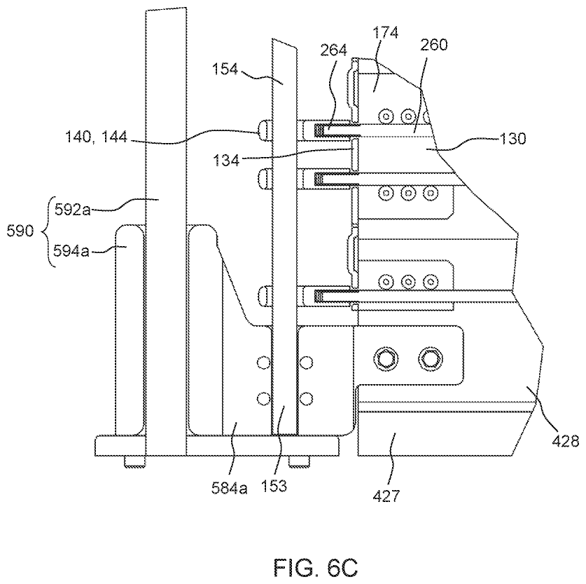

FIG. 5 shows a roller shutter 500 according to various embodiments. FIG. 6A shows a cross sectional view of the shutter curtain 120 of the roller shutter 500 of FIG. 5 when the shutter curtain 120 is fully lowered according to various embodiments. FIG. 6B shows a shows a cross sectional view of the shutter curtain 120 of the roller shutter 500 of FIG. 6A when the shutter curtain 120 is partially lowered according to various embodiments. FIG. 6C shows an enlarged view of the circled portion in FIG. 6A illustrating a retaining arrangement 580 according to various embodiments. According to various embodiments, the roller shutter 500 of FIG. 5 may, similar to the roller shutter 100 of FIG. 1, be configured for mitigating an impact force applied to the roller shutter 500. According to various embodiments, the roller shutter 500 of FIG. 5 may be similar to the roller shutter 100 of FIG. 1 in all aspect, except that the roller shutter 500 of FIG. 5 includes the retaining arrangement 580 (or the retaining-and-alignment arrangement) which is different from the retaining arrangement 480 of the roller shutter 100 as shown in FIG. 4A to FIG. 4C and that the roller shutter 500 of FIG. 5 further include a sliding guide arrangement 590. According to various embodiments, the roller shutter 500 of FIG. 5 may, similar to the roller shutter 100 of FIG. 1, include, inter alia, the rotatable drum 110; the shutter curtain 120 having the series of three or more elongate slats 130; the first row 144 of eyelet-structures 140 and the second row 146 of eyelet-structures 140 formed along the first and second side borders 124, 126, respectively, of the shutter curtain 120; the at least one elongate reinforcing member 260, 360a, 360b extending within each elongate slat 130; and the first longitudinal end cover 174 and the second longitudinal end cover 176 coupled to each elongate slat 130.

According to various embodiments, the roller shutter 500 may include the retaining arrangement 580 (or the retaining-and-alignment arrangement). According to various embodiments, the retaining arrangement 580 may, similar to the retaining arrangement 480 of FIG. 4A to FIG. 4C, be configured to align a bottom rail 428 of the shutter curtain 120 to a predetermined position on a ground and to retain or restrain the bottom rail 428 from sideways or lateral movements in said position when the shutter curtain 120 is lowered. According to various embodiments, the retaining arrangement 580 may, similar to the retaining arrangement 480 of FIG. 4A to FIG. 4C, be configured such that the bottom rail 428 of the shutter curtain 120 may be brought into alignment with the predetermined position on the ground as the shutter curtain 120 is being lowered. Further, the retaining arrangement 580 may, similar to the retaining arrangement 480 of FIG. 4A to FIG. 4C, be configured such that the bottom rail 428 may not be easily moved out of alignment (or moved sideways or moved laterally) once the shutter curtain 120 is fully lowered. Accordingly, the retaining arrangement 580 may be configured for laterally retaining the bottom rail 428 against sideways, or horizontal, or lateral movements.

According to various embodiments, the alignment arrangement 580 may differ from the alignment arrangement 480 of FIG. 4A to FIG. 4C, in that the retaining arrangement 580 may include two brackets 582a, 582b, each bracket 582a, 582b having a Y-shaped slot, fixed to the ground and two corresponding insert members 584a, 584b attached to the bottom rail 428 of the shutter curtain 120. According to various embodiments, as the two corresponding insert members 584a, 584b fit into the two brackets 582a, 582b when the shutter curtain 120 is lowering, the bottom rail 428 of the shutter curtain 120 may be adjusted according to a straight line joining the two brackets 582a, 582b. According to various embodiments, each of the two corresponding insert members 584a, 584b may have a thickness that correspond to a thickness of the slot of the respective bracket 582a, 582b which the corresponding insert member 584a, 584b is to be fitted into or inserted. According to various embodiments, the two brackets 582a, 582b may be fixed to the ground in a spaced apart manner such that, when the shutter curtain is lowered, a first bracket 582a may be adjacent a first longitudinal end 427 of the bottom rail 428 of the shutter curtain 120 and a second bracket 582b may be adjacent to a second longitudinal end 429 of the bottom rail 428 of the shutter curtain 120. Accordingly, a first insert members 584a may be attached to the first longitudinal end 427 of the bottom rail 428 of the shutter curtain 120 and a second insert members 584b may be attached to the second longitudinal end 429 of the bottom rail 428 of the shutter curtain 120.

According to various embodiments, the second cord end 153 of the respective cords 154, 156 may be coupled to the respective first and second insert members 584a, 584b. According to various embodiments, the respective first and second insert members 584a, 584b may respectively serve as the stopper element 155 of the second cord end 153 of the respective cords 154, 156. Accordingly, the stopper element 155 of the second cord end 153 of the respective cords 154, 156 may respectively serve as a physical barrier to restrain or restrict or obstruct the respective rows of eyelet-structures 140 from sliding out from the second cord end 153 of the respective cords 154, 156. With the second cord end 153 of the respective cords 154, 156 being coupled to the bottom rail 428, via the respective first and second insert members 584a, 584b, the second cord end 153 of the respective cords 154, 156 may be restrained by the retaining arrangement 580 from sideways or lateral movements due to the bottom rail 428 being restrained or retained by the retaining arrangement 580 when the shutter curtain 120 is lowered. According to various embodiments, with the first and second cords 154, 156 extending from the rotatable drum 110 to the bottom rail 428, all the slats 130 of the shutter curtain 120 may be confined within the length of the respective cords 154, 156. Accordingly, when the shutter curtain 120 is lowered, the shutter curtain 120 may weigh down the second cord end 153 of the respective cords 154, 156 to the ground. Hence, the respective cords 154, 156 may be extending from the rotatable drum 110 to the ground such that the respective cords 154, 156 may provide additional support to the shutter curtain 120 in a manner so as to mitigate impact force applied on the shutter curtain 120.

According to various embodiments, the roller shutter 500 may further include a sliding guide arrangement 590 which may include a first guiding rod 592a and a second guiding rod 592b fixed to the ground in an upright orientation and spaced apart in a manner so as to be respectively disposed adjacent the first and second side borders 124, 126, respectively, of the shutter curtain 120 when the shutter curtain 120 is lowered. Accordingly, the first guiding rod 592a and the second guiding rod 592b may be erected from the ground upwards and set apart from each other by a distance equivalent or close to a width of the shutter curtain 120 measured from the first side border 124 to the second side border 126. According to various embodiments, the sliding guide arrangement 590 may further include a first sliding element 594a and a second sliding element 594b attached to the first longitudinal end 427 and the second longitudinal end 429, respectively, of the bottom rail 428 of the shutter curtain 120. Accordingly, the first sliding element 594a may be protruding from the first longitudinal end 427 of the bottom rail 428 of the shutter curtain 120 and the second sliding element 594b may be protruding from the second longitudinal end 429 of the bottom rail 428 of the shutter curtain 120. According to various embodiments, the first sliding element 594a may attached to the first longitudinal end 427 of the bottom rail 428 via the first insert member 584a, and the second sliding element 594b may be attached to the second longitudinal end 429 of the bottom rail 428 via the second insert member 584b. According to various embodiments, the first sliding element 594a may be in engagement with the first guiding rod 592a and the second sliding element 594b is in engagement with the second guiding rod 592b. According to various embodiments, each of the first and second sliding elements 594a, 594b may be of a hollow cylindrical shape having a central through-hole whereby the first guiding rod 592a is passed through the central through-hole of the first sliding element 594a and the second guiding rod 592b is passed through the central through-hole of the second sliding element 594b such that each of the first and second sliding elements 594a, 594b may slide along respective first and second guiding rod 592a, 592b.

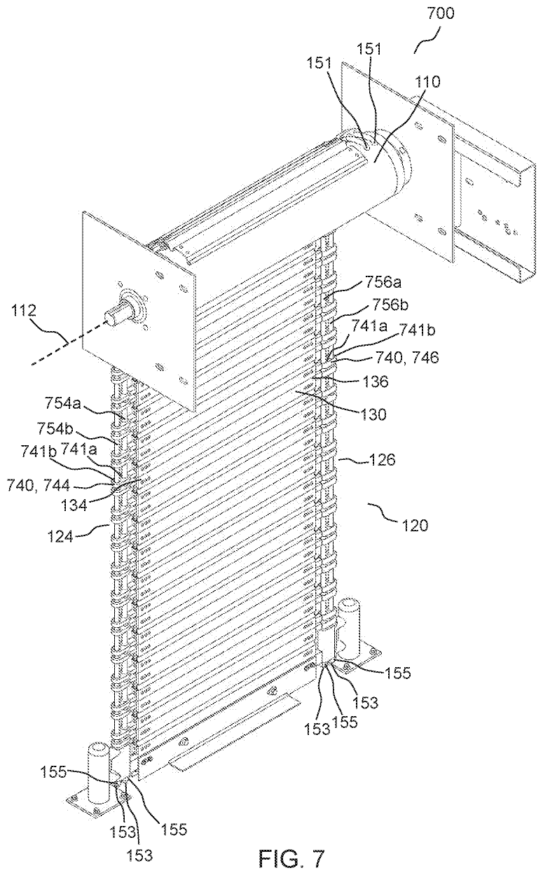

FIG. 7 shows a roller shutter 700 according to various embodiments. According to various embodiments, the roller shutter 700 of FIG. 7 may, similar to the roller shutter 100 of FIG. 1, be configured for mitigating an impact force applied to the roller shutter 700. According to various embodiments, the roller shutter 700 of FIG. 7 may be similar to the roller shutter 100 of FIG. 1 in all aspect. According to various embodiments, the at least one eyelet structure of respective elongate slat of the roller shutter 700 of FIG. 7 may include at least one double-eyelets-structure 740. According to various embodiments the roller shutter 700 of FIG. 7 may include a first row 744 of double-eyelets-structures 740 and a second row 746 of double-eyelets-structures 740 formed along the first and second side borders 124, 126, respectively, of the shutter curtain 120.

According to various embodiments, the roller shutter 700 of FIG. 7 may, similar to the roller shutter 100 of FIG. 1, include the rotatable drum 110. According to various embodiments, the roller shutter 700 of FIG. 7 may, similar to the roller shutter 100 of FIG. 1, include the shutter curtain 120. According to various embodiments, the shutter curtain 120 be configured to be wound on and off the rotatable drum 110 in a manner so as to be raised or lowered for opening or closing an entrance.

According to various embodiments, the shutter curtain 120 of the roller shutter 700 of FIG. 7 may, similar to the roller shutter 100 of FIG. 1, include the series of three or more elongate slats 130. Accordingly, the three or more elongate slats 130 may be arranged in sequence to form a set of three or more successive elongate slats 130. According to various embodiments, the series of three or more elongate slats 130 may be pivotally interlocked in a longitudinal-edge-to-longitudinal-edge arrangement one after another. According to various embodiments, the series of three or more elongate slats 130 may be arranged parallel to the rotational axis 112 of the rotatable drum 110. According to various embodiments, the series of three or more elongate slats 130 may be capable of being wound on and off the rotatable drum 110 together in an interlocked state.

According to various embodiments, each of the elongate slats 130 of the shutter curtain 120 of the roller shutter 700 of FIG. 7 may, similar to the roller shutter 100 of FIG. 1, have the first longitudinal end portion 134 and the second longitudinal end portion 136. According to various embodiments, the first and second longitudinal end portions 134, 136 of each elongate slat 130 may be respective portions at respective extremity, lengthwise, of said elongate slat 130. According to various embodiments, the first and second longitudinal end portions 134, 136 may be respectively aligned to form the first side border 124 and the second side border 126, respectively, of the shutter curtain 120. According to various embodiments, all the first longitudinal end portions 134 of the series of three or more elongate slats 130 may be aligned or brought into alignment to form a continuous line so as to form the first side border 124 of the shutter curtain 120. According to various embodiments, all the second longitudinal end portions 136 of the series of three or more elongate slats 130 may be aligned or brought into alignment to form a continuous line so as to form the second side border 126 of the shutter curtain 120.

According to various embodiments, the first longitudinal end portion 134 and the second longitudinal end portion 136 of each elongate slat 130 of the series of three or more elongate slats 130 may be respectively provided with at least one double-eyelets-structure 740 which protrudes therefrom. According to various embodiments, each elongate slat 130 of the series of three or more elongate slats 130 may include at least one double-eyelets-structure 740 protruding or jutting out from the first longitudinal end portion 134 of said elongate slat 130. According to various embodiments, each elongate slat 130 of the series of three or more elongate slats 130 may include at least one double-eyelets-structure 740 protruding or jutting out from the second longitudinal end portion 136 of said elongate slat 130. Accordingly, every one of the three or more elongate slats 130 may include at least one double-eyelets-structure 740 protruding from respective first longitudinal end portion 134 thereof and at least one double-eyelets-structure 740 protruding from respective second longitudinal end portion 136 thereof.

According to various embodiments, each double-eyelets-structure 740 may include an elongate part extending longitudinally from respective elongate slat 130. According to various embodiments, the elongate part of said double-eyelets-structure 740 may be extending from respective longitudinal end portions 134, 136 of respective elongate slat 130 along the longitudinal direction of the respective elongate slat 130. According to various embodiments, the elongate part of said double-eyelets-structure 740 may include two eyeholes, an inner eyehole 741a and an outer eyehole 741b, forming the double eyelets. According to various embodiments, the inner eyehole 741a may be located proximal to the respective longitudinal end portions 134,135 of respective elongate slat 130 and the outer eyehole 741b may be located distal away from the respective longitudinal end portions 134,135 of respective elongate slat 130. According to various embodiments, the two eyeholes 741a, 741b may be lined abreast so as to be aligned side-by-side along the longitudinal direction of the respective elongate slat 130.

According to various embodiments, the first row 744 of double-eyelets-structures 740 and the second row 746 of double-eyelets-structures 740 may be formed along the first and second side borders 124, 126, respectively, of the shutter curtain 120. According to various embodiments, all the double-eyelets-structures 740 of all the first longitudinal end portions 134 of the series of three or more elongate slats 130 may be arranged or placed in succession into a line so as to make up the first row 744 of double-eyelets-structures 740 running alongside the first side border 124 of the shutter curtain 120. According to various embodiments, the inner eyeholes 741a (or inner holes) of all the double-eyelets-structures 740 of all the first longitudinal end portions 134 of the series of three or more elongate slats 130 may be in line with each other, and the outer eyeholes 741b (or outer holes) of all the double-eyelets-structures 740 of all the first longitudinal end portions 134 of the series of three or more elongate slats 130 may be in line with each other. According to various embodiments, all the double-eyelets-structures 740 of all the second longitudinal end portions 136 of the series of three or more elongate slats 130 may be arranged or placed in succession into a line so as to make up the second row 746 of double-eyelets-structures 740 running alongside the second side border 126 of the shutter curtain 120. According to various embodiments, the inner eyeholes 741a (or inner holes) of all the double-eyelets-structures 740 of all the second longitudinal end portions 136 of the series of three or more elongate slats 130 may be in line with each other, and outer eyeholes 741b (or outer holes) of all the double-eyelets-structures 740 of all the second longitudinal end portions 136 of the series of three or more elongate slats 130 may be in line with each other.

According to various embodiments, the roller shutter 700 of FIG. 7 may include a first inner cord 754a, a first outer cord 754b, a second inner cord 756a and a second outer cord 756b. Accordingly, the roller shutter 700 may include four cords 754a, 754b, 756a, 756b. According to various embodiments, each of the four cords 754a, 754b, 756a, 756b may include, but not limited to, a steel wire, a steel cable, or a steel cord. According to various embodiments, the first inner cord 754a may be strung loosely through all inner eyeholes 741a of the double-eyelets-structures 740 of the first row 744 of double-eyelets-structures 740. According to various embodiments, the first outer cord 754b may be strung loosely through all outer eyeholes 741b of the double-eyelets-structures 740 of the first row 744 of double-eyelets-structures 740. Accordingly, all the double-eyelets-structures 740 of the first row 744 of double-eyelets-structures 740 may be connected by the first inner cord 754a and the first outer cord 754b which are passed through or threaded through respective inner and outer eyeholes 741a, 741b of all the double-eyelets-structures 740 of the first row 744 of double-eyelets-structures 740. According to various embodiments, the second inner cord 756a may be strung loosely through all the inner eyeholes 741a of the second row 746 of double-eyelets-structures 740. According to various embodiments, the second outer cord 756b may be strung loosely through all the outer eyeholes 741b of the second row 746 of double-eyelets-structures 740. Accordingly, all the double-eyelets-structures 740 of the second row 746 of double-eyelets-structures 740 may be connected by the second inner cord 756a and second outer cord 756b which are passed through or threaded through respective inner and outer eyeholes 741a, 741b of all the double-eyelets-structures 740 of the second row 746 of double-eyelets-structures 740.

According to various embodiments, each of the four cords 754a, 754b, 756a, 756b may be configured to confine all double-eyelets-structures 740 of respective row 744, 746 of double-eyelets-structures 740 within a length of each cord 754a, 754b, 756a, 756b. According to various embodiments, the first inner cord 754a may be configured to keep or retain, via the inner eyeholes 741a, all the double-eyelets-structures 740 of the first row 744 of double-eyelets-structures 740 within bounds or limits as defined by the length of the first inner cord 754a. Accordingly, all the double-eyelets-structures 740 of the first row 744 of double-eyelets-structures 740 may be placed or put upon, via the inner eyeholes 741a, the first inner cord 754a in a manner so as to be non-separable from the first inner cord 754a and be restrained from sliding out of the first inner cord 754a. According to various embodiments, the first outer cord 754b may be configured to keep or retain, via the outer eyeholes 741b, all the double-eyelets-structures 740 of the first row 744 of double-eyelets-structures 740 within bounds or limits as defined by the length of the first outer cord 754b. Accordingly, all the double-eyelets-structures 740 of the first row 744 of double-eyelets-structures 740 may be placed or put upon, via the outer eyeholes 741b, the first outer cord 754b in a manner so as to be non-separable from the first outer cord 754b and be restrained from sliding out of the first outer cord 754b. According to various embodiments, the length of the first inner cord 754a may be the same as the length of the first outer cord 754b.

According to various embodiments, the second inner cord 756a may be configured to keep or retain, via the inner eyeholes 741a, all the double-eyelets-structures 740 of the second row 746 of double-eyelets-structures 740 within bounds or limits as defined by the length of the second inner cord 756a. Accordingly, all the double-eyelets-structures 740 of the second row 746 of double-eyelet-structures 740 may be placed or put upon, via the inner eyeholes 741a, the second inner cord 756a in a manner so as to be non-separable from the second inner cord 756a and be restrained from sliding out of the second inner cord 756a. According to various embodiments, the second outer cord 756b may be configured to keep or retain, via the outer eyeholes 741b, all the double-eyelets-structures 740 of the second row 746 of double-eyelets-structures 740 within bounds or limits as defined by the length of the second outer cord 756b. Accordingly, all the double-eyelets-structures 740 of the second row 746 of double-eyelet-structures 740 may be placed or put upon, via the outer eyeholes 741b, the second outer cord 756b in a manner so as to be non-separable from the second outer cord 756b and be restrained from sliding out of the second outer cord 756b. According to various embodiments, the length of the second inner cord 756a may be the same as the length of the second outer cord 756b. According to various embodiments all the four cords 754a, 754b, 756a, 756b may have the same length.

According to various embodiments, as shown in FIG. 7, each of the four cords 754a, 754b, 756a, 756b may include a first cord end 151 fixedly coupled to the rotatable drum 110 and a second cord end 153 having a stopper element 155 which is configured to prevent the second cord end 153 of said cord 754a, 754b, 756a, 756b from sliding out of the respective row 744, 746 of double-eyelets-structures 740. According to various embodiments, with the first cord end 151 of each cord 754a, 754b, 756a, 756b fixedly coupled to the rotatable drum 110, the rotatable drum 110 may serve as a physical barrier to restrain or restrict or obstruct the double-eyelets-structures 740 from sliding out from the first cord end 151. According to various embodiments, with the stopper element 155 at the second cord end 153 of each cord 754a, 754b, 756a, 756b, the stopper element 155 may serve as a physical barrier to restrain or restrict or obstruct the double-eyelets-structures 740 from sliding out from the second cord end 153. According to various embodiments, the stopper element 155 may include, but not limited to, a crimp end, a cord end cap, a knotted end, a bulged end, or an expanded end.

According to various embodiments, not shown, each cord may include a first cord end having a first stopper element which is configured to prevent the first cord end of said cord from sliding out of the respective row of eyelet-structures, and a second cord end having a second stopper element which is configured to prevent the second cord end of said cord from sliding out of the respective row of eyelet-structures. According to various embodiments, with the first stopper element and the second stopper element respectively disposed at the first cord end and the second cord end, respectively, of said cord, the first stopper element at the first cord end may serve as a physical barrier to restrain or restrict or obstruct the eyelet-structures from sliding out from the first cord end and the second stopper element at the second cord end may serve as a physical barrier to restrain or restrict or obstruct the eyelet-structures from sliding out from the second cord end. According to various embodiments, the first stopper element and the second stopper element each may include, but not limited to, a crimp end, a cord end cap, a knotted end, a bulged end, or an expanded end.

According to various embodiments, the first inner cord 754a, the first outer cord 754b, the second inner cord 756a and the second outer cord 756b may respectively cooperate with the first row 744 of double-eyelets-structures 740 and the second row 746 of double-eyelets-structures 740 in a manner so as to collectively provide additional securing points and/or holding points for the respective elongate slats such that the respective elongate slats may be retained or held even if the respective elongate slats are broken or fracture from an impact force. According to various embodiments, the first inner cord 754a, the first outer cord 754b, the second inner cord 756a and the second outer cord 756b together with the first row 744 of double-eyelets-structures 740 and the second row 746 of double-eyelets-structures 740 may be an assemblage of interacting and/or interdependent features forming a unified whole system for mitigating an impact force.

According to various embodiments, the at least one double-eyelets-structure 740 of each longitudinal end portion 134, 136 of each elongate slat 130 may be protruding in the longitudinal direction of said elongate slat 130. Accordingly, each elongate slat 130 of the series of three or more elongate slats may include at least one double-eyelets-structure 740 protruding from the first longitudinal end portion 134 thereof in a direction of a length of said elongate slat 130 and at least one double-eyelets-structure 740 protruding from the second longitudinal end portion 134 thereof in the direction of the length of said elongate slat 130. According to various embodiments, the at least one double-eyelets-structure 740 of each longitudinal end portion 134, 136 of each elongate slat 130 may be oriented with an axis of respective eyeholes of the at least one double-eyelets-structure 740 of each longitudinal end portion 134, 136 of each elongate slat 130 in a direction parallel to a breadth of said elongate slat 130. Accordingly, the respective axis of the inner and outer eyeholes 741a, 741b of the at least one double-eyelets-structure 140 of each longitudinal end portion 134, 136 of each elongate slat 130 may be parallel to a perpendicular direction extending between two longitudinal edges of said elongate slat 130.

According to various embodiments, as shown in FIG. 7, each of the elongate slats 130 may include two double-eyelets-structures 740 protruding from each longitudinal end portion 134, 136 of said elongate slat 130. According to various embodiments, the first longitudinal end portion 134 of each elongate slat 130 may include two double-eyelets-structures 740 protruding therefrom, and the second longitudinal end portion 136 of each elongate slat 130 may include two double-eyelets-structures 740 protruding therefrom.

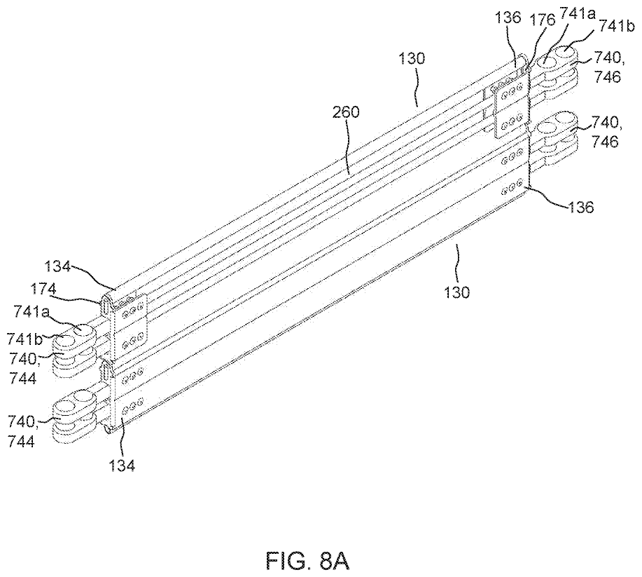

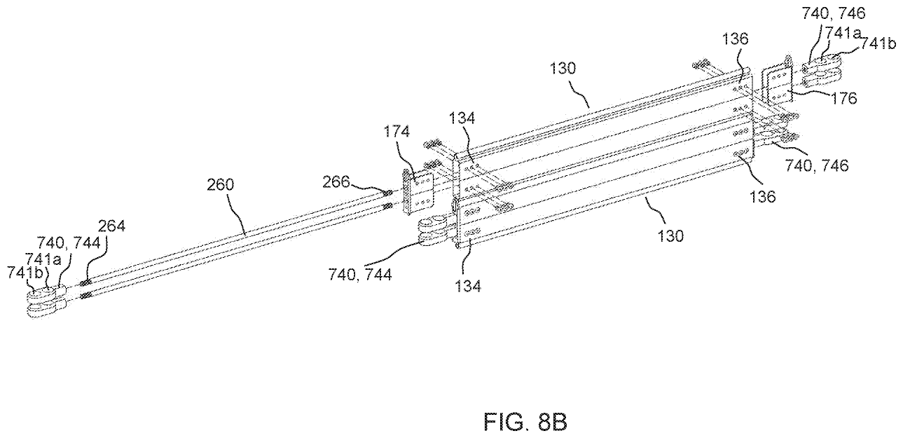

FIG. 8A shows two pivotally interlocked elongate slats 130 of the shutter curtain 120 of the roller shutter 700 of FIG. 7 with a surface of one of the elongate slats 130 cutaway to show an interior of said elongate slat 130 according to various embodiments. FIG. 8B shows the two pivotally interlocked elongate slats 130 of FIG. 2A with one of the elongate slats 130 in an exploded view according to various embodiments.

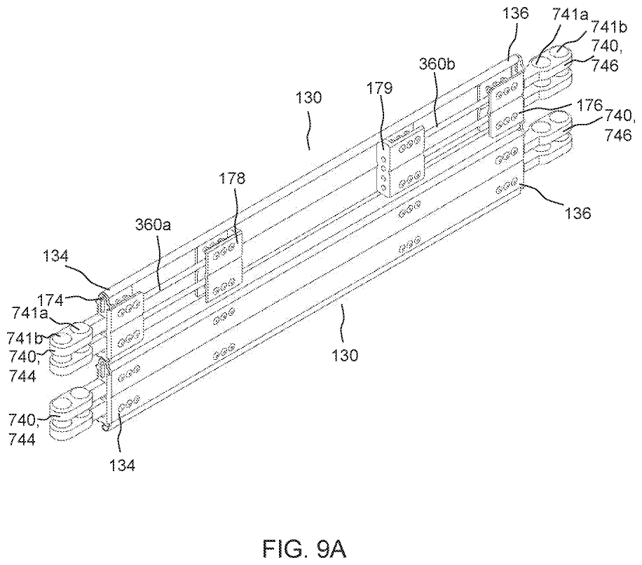

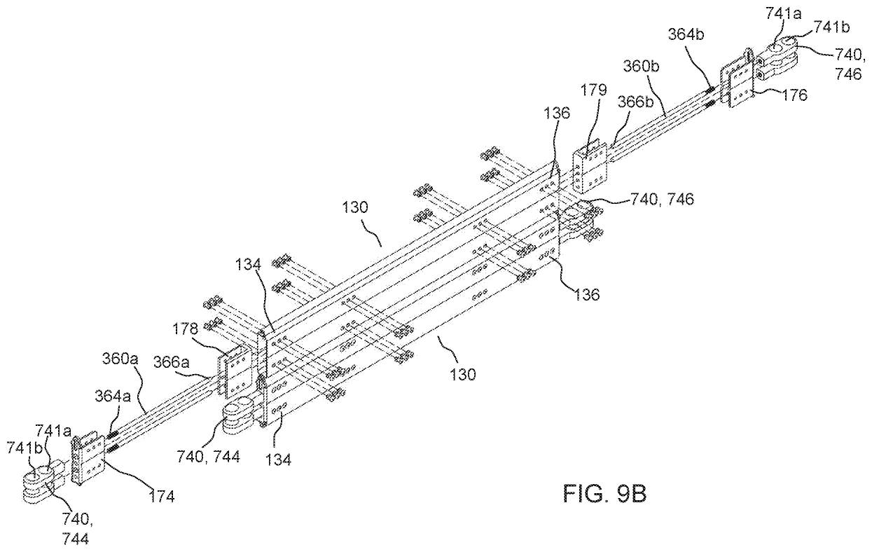

According to various embodiments, the roller shutter 700 of FIG. 7 may, similar to the roller shutter 100 of FIG. 1, further include the plurality of elongate reinforcing members 260, 360a, 360b (see FIG. 9A and FIG. 9B). According to various embodiments, each of the plurality of elongate reinforcing members 260, 360a, 360b may include, but not limited to, a rod, a pole, a bar, a tube, a wire, a cable, or a cord. According to various embodiments, each of the elongate slats 130 may include at least one elongate reinforcing member 260, 360a, 360b extending within said elongate slat 130 in a manner so as to be aligned longitudinally to said elongate slat 130. According to various embodiments, the at least one elongate reinforcing member 260, 360a, 360b of each elongate slat 130 may be secured or coupled to said elongate slat 130 in a manner so as to strengthen or toughen said elongate slat 130. Accordingly, the at least one elongate reinforcing member 260, 360a, 360b of each elongate slat 130 may serve to support said elongate slat 130 to enhance its resistance against an impact force and/or to mitigate the impact force.

According to various embodiments, as shown in FIG. 8A and FIG. 8B, the at least one elongate reinforcing member 260 of at least one elongate slat 130 may extend across an entire length of said elongate slat 130. Accordingly, the at least one elongate reinforcing member 260 may span across a full length of the at least one elongate slat 130.

According to various embodiments, as shown in FIG. 8A and FIG. 8B, the at least one double-eyelets-structure 740 of each longitudinal end portion 134, 136 of the at least one elongate slat 130 may be integral with the at least one reinforcing member 260 extending within the at least one elongate slat 130. According to various embodiments, the at least one double-eyelets-structure 740 of the first longitudinal end portion 134 of the at least one elongate slat 130 may be integrally connected to the first longitudinal end 264 of the at least one elongate reinforcing member 260 and the at least one double-eyelets-structure 740 of the second longitudinal end portion 136 of the at least one elongate slat 130 may be integrally connected to the second longitudinal end 266 of the at least one elongate reinforcing member 260. Accordingly, the at least one double-eyelets-structure 740 of the first longitudinal end portion 134 of the at least one elongate slat 130, the at least one double-eyelets-structure 740 of the second longitudinal end portion 136 of the at least one elongate slat 130, and the at least one elongate reinforcing member 260 may be integrated or joined in such a way so as to form a single unit which may serve to provide additional securing points and/or holding points for the at least one elongate slat 130 and to strengthen the at least one elongate slat 130 to enhance resistance against an impact force and/or to mitigate the impact force.

According to various embodiments, as shown in FIG. 8A and FIG. 8B, the at least one elongate slat 130 of the roller shutter 700 of FIG. 7 may, similar to the roller shutter 100 of FIG. 1, include a first longitudinal end cover 174 and a second longitudinal end cover 176. According to various embodiments, the first longitudinal end cover 174 may be fixedly coupled to the first longitudinal end portion 134 of the at least one elongate slat 130, and the second longitudinal end cover 176 may be fixedly coupled to the second longitudinal end portion 136 of the at least one elongate slat 130.

According to various embodiments, the at least one reinforcing member 260 may be inserted through the first longitudinal end cover 174 and the second longitudinal end cover 176 so as to be extending within the at least one elongate slat 130. According to various embodiments, the at least one double-eyelets-structure 740 at the first longitudinal end portion 134 of the at least one elongate slat 130 may then be fastened or bond to the first longitudinal end 264 of the at least one elongate reinforcing member 260 and the at least one double-eyelets-structure 740 at the second longitudinal end portion 136 of the at least one elongate slat 130 may then be fastened or bond to the second longitudinal end 266 of the at least one elongate reinforcing member 260. Accordingly, in this manner, the first longitudinal end 264 of the at least one elongate reinforcing member 260 may be joined to the at least one double-eyelets-structure 740 at the first longitudinal end portion 134 of the at least one elongate slat 130 with the at least one double-eyelets-structure 740 outside the first longitudinal end cover 174, and the second longitudinal end 266 of the at least one elongate reinforcing member 260 may be joined to the at least one double-eyelets-structure 740 at the second longitudinal end portion 136 of the at least one elongate slat 130 with the at least one double-eyelets-structure 740 outside the second longitudinal end cover 176.

According to various embodiments, as shown in FIG. 8A and FIG. 8B, the at least one elongate reinforcing member 260 of the at least one elongate slat 130 may include two identical elongate reinforcing member 260, each may extend across an entire length of said elongate slat 130. According to various embodiments, the two identical elongate reinforcing member 260 may be joined to the at least one elongate slat 130 in the same manner.

FIG. 9A shows two pivotally interlocked elongate slats 130 of the shutter curtain 120 of the roller shutter 700 of FIG. 7 with a surface of one of the elongate slats 130 cutaway to show a variant of an interior of said elongate slat 130 according to various embodiments. FIG. 9B shows the two pivotally interlocked elongate slats 130 of FIG. 9A with one of the elongate slats 130 in an exploded view according to various embodiments.

According to various embodiments, as shown in FIG. 9A and FIG. 9B, the at least one elongate slat 130 may include a first elongate reinforcing member 360a and a second elongate reinforcing member 360b. According to various embodiments, the first elongate reinforcing member 360a may extend longitudinally inwards from the first longitudinal end portion 134 of the at least one elongate slat 130 and the second elongate reinforcing member 360b may extend longitudinally inwards from the second longitudinal end portion 136 of the at least one elongate slat 130. According to various embodiments, the first elongate reinforcing member 360a may extend longitudinally inwards for more than a tenth of a length, or a fifth of a length, or a quarter of a length of the at least one elongate slat 130 and the second elongate reinforcing member 360b may extend longitudinally inwards for more than a tenth of a length, or a fifth of a length, or a quarter of a length of the at least one elongate slat 130.

According to various embodiments, as shown in FIG. 9A and FIG. 9B, the at least one double-eyelets-structure 740 of the first longitudinal end portion 134 of the at least one elongate slat 130 may be integral with the first elongate reinforcing member 360a, and the at least one double-eyelets-structure 740 of the second longitudinal end portion 136 of the at least one elongate slat 130 may be integral with the second elongate reinforcing member 360b. According to various embodiments, the at least one double-eyelets-structure 740 of the first longitudinal end portion 134 of the at least one elongate slat 130 may be integrally connected to the first longitudinal end 364a of the first elongate reinforcing member 360a and the at least one double-eyelets-structure 740 of the second longitudinal end portion 136 of the at least one elongate slat 130 may be integrally connected to the first longitudinal end 364b of the second elongate reinforcing member 360b. Accordingly, the at least one double-eyelets-structure 140 of the first longitudinal end portion 134 of the at least one elongate slat 130 and the first elongate reinforcing member 360a may be integrated or joined in such a way as to form a first single unit, and the at least one double-eyelets-structure 740 of the second longitudinal end portion 136 of the at least one elongate slat 130 and the second elongate reinforcing member 360b may be integrated or joined in such a way as to form a second single unit. According to various embodiments, the first single unit and the second single unit may cooperatively serve to provide additional securing points and/or holding points for the at least one elongate slat 130 and to strengthen the at least one elongate slat 130 to enhance resistance against an impact force and/or to mitigate the impact force.

According to various embodiments, as shown in FIG. 9A and FIG. 9B, the at least one elongate slat 130 may include a first longitudinal end cover 174 and a second longitudinal end cover 176. Further, the at least one elongate slat 130 may include a first intermediate bracket 178 and a second intermediate bracket 179. According to various embodiments, the first longitudinal end cover 174 may be fixedly coupled to the first longitudinal end portion 134 of the at least one elongate slat 130, and the second longitudinal end cover 176 may be fixedly coupled to the second longitudinal end portion 136 of the at least one elongate slat 130. According to various embodiments, the first intermediate bracket 178 and the second intermediate bracket 179 each may be inserted inside the at least one elongate slat 130 and may be fixedly coupled to a predetermined position inside the at least one elongate slat 130. According to various embodiments, the first intermediate bracket 178 may be positioned at a predetermined distance from the first longitudinal end cover 174 and the second intermediate bracket 179 may be positioned at a predetermined distance from the second longitudinal end cover 176.

According to various embodiments, the first reinforcing member 360a may be inserted through the first longitudinal end cover 174 so as to be extending longitudinally inwards from the first longitudinal end portion 134 of the at least one elongate slat 130. According to various embodiments, the second reinforcing member 360b may be inserted through the second longitudinal end cover 176 so as to be extending longitudinally inwards from the second longitudinal end portion 136 of the at least one elongate slat 130. According to various embodiments, the at least one double-eyelets-structure 740 at the first longitudinal end portion 134 of the at least one elongate slat 130 may then be fastened or bond to the first longitudinal end 364a of the first elongate reinforcing member 360a and the at least one double-eyelets-structure 740 at the second longitudinal end portion 136 of the at least one elongate slat 130 may then be fastened or bond to the first longitudinal end 364b of the second elongate reinforcing member 360b. According to various embodiments, the second longitudinal end 366a of the first elongate reinforcing member 360a may be fastened or bonded to the first intermediate bracket 178, and the second longitudinal end 366b of the second elongate reinforcing member 360b may be fastened or bonded to the second intermediate bracket 179. Accordingly, in this manner, the first elongate reinforcing member 360a may be joined to the at least one elongate slat 130 via the the first longitudinal end cover 174, the at least one double-eyelets-structure 740 at the first longitudinal end portion 134, and the first intermediate bracket 178. Further, the second elongate reinforcing member 360b may be joined to the at least one elongate slat 130 via the the second longitudinal end cover 176, the at least one double-eyelets-structure 740 at the second longitudinal end portion 136, and the second intermediate bracket 179.

According to various embodiments, as shown in FIG. 9A and FIG. 9B, the at least one elongate slat 130 may include two identical pairs of the first and second elongate reinforcing members 360a, 360b. According to various embodiments, the two identical pairs of the first and second elongate reinforcing members 360a, 360b may be joined to the at least one elongate slat 130 in the same manner.

According to various embodiments, each of the elongate slats 130 of the shutter curtain 120 of the roller shutter 700 of FIG. 7 may include the at least one elongate reinforcing member 260 of FIG. 8A and FIG. 8B which extends across an entire length of said elongate slat 130. According to various embodiments, each of the elongate slats 130 of the shutter curtain 120 of the roller shutter 700 of FIG. 7 may include the first and second elongate reinforcing members 360a, 360b of FIG. 9A and FIG. 9B. According to various embodiments, the series of three of more elongate slats 130 of the shutter curtain 120 of the roller shutter 700 may include at least one elongate slat 130 having the at least one elongate reinforcing member 260 of FIG. 8A and FIG. 8B which extends across an entire length of said elongate slat 130 and at least one elongate slat 130 having the first and the second elongate reinforcing members 360a, 360b of FIG. 9A and FIG. 9B.

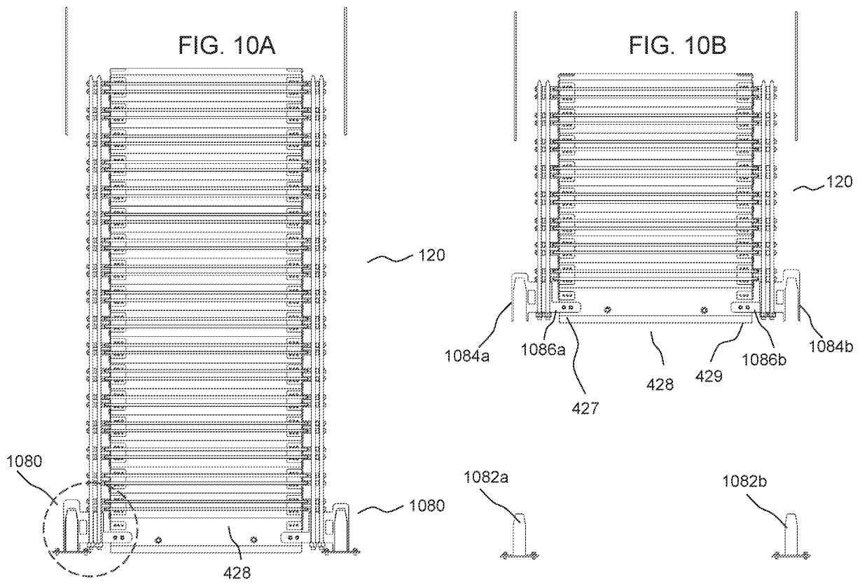

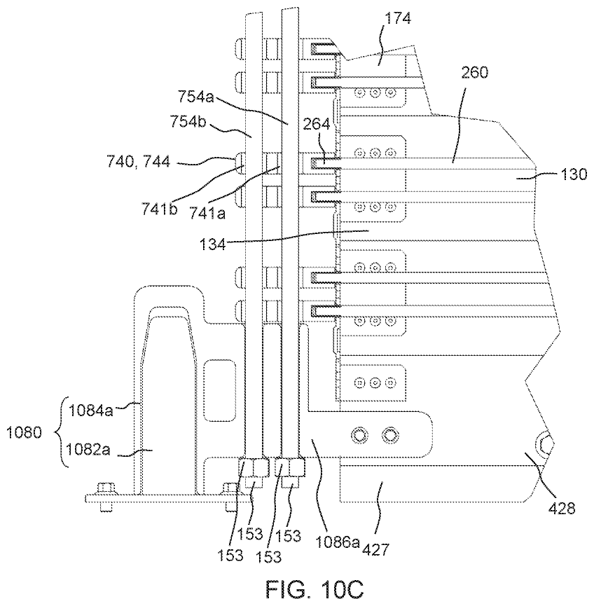

FIG. 10A shows a cross sectional view of the shutter curtain 120 of the roller shutter 700 of FIG. 7 when the shutter curtain 120 is fully lowered according to various embodiments. FIG. 10B shows a cross sectional view of the shutter curtain 120 of the roller shutter 700 of FIG. 7 when the shutter curtain 120 is partially lowered according to various embodiments. FIG. 10C shows an enlarged view of the circled portion in FIG. 10A illustrating a retaining arrangement 1080 (or a retaining-and-alignment arrangement) of the roller shutter 700 of FIG. 7 according to various embodiments.

According to various embodiments, the roller shutter 700 may, similar to the roller shutter 100 of FIG. 1, further include the retaining arrangement 1080 (or the retaining-and-alignment arrangement) configured to align a bottom rail 428 of the shutter curtain 120 to a predetermined position on a ground and to retain or restrain the bottom rail 428 from sideways or lateral movements in said position when the shutter curtain 120 is lowered. According to various embodiments, the retaining arrangement 1080 may be configured such that the bottom rail 428 of the shutter curtain 120 may be brought into alignment with the predetermined position on the ground as the shutter curtain 120 is being lowered. Further, the retaining arrangement 1080 may be configured such that the bottom rail 428 may not be easily moved out of alignment (or moved sideways or moved laterally) or may be held in place with respect to horizontal movement once the shutter curtain 120 is fully lowered. Accordingly, the retaining arrangement 1080 may be configured for laterally retaining the bottom rail 428 against sideways, or horizontal, or lateral movements.

According to various embodiments, the retaining arrangement 1080 may include two bollards 1082a, 1082b fixed to the ground and two corresponding caps 1084a, 1084b attached to the bottom rail 428 of the shutter curtain 120. According to various embodiments, as the two corresponding caps 1084a, 1084b fit over the two bollards 1082a, 1082b when the shutter curtain 120 is lowering, the bottom rail 428 of the shutter curtain 120 may be adjusted according to a straight line joining the two bollards 1082a, 1082b. According to various embodiments, each of the two bollards 1082a, 1082b may include, but not limited to, a conical bollard or a frusto-conical bollard. According to various embodiments, each of the two bollards 1082a, 1082b may have a height higher than a height of the bottom rail 428 of the shutter curtain 120. According to various embodiments, each of the two corresponding caps 1084a, 1084b may include a cavity with a shape that correspond to the shape of the bollard 1082a, 1082b which the corresponding cap 1084a, 1084b is to be fitted on. According to various embodiments, the two bollards 1082a, 1082b may be fixed to the ground in a spaced apart manner such that, when the shutter curtain is lowered, a first bollard 1082a may be adjacent a first longitudinal end 427 of the bottom rail 428 of the shutter curtain 120 and a second bollard 1082b may be adjacent to a second longitudinal end 429 of the bottom rail 428 of the shutter curtain 120. Accordingly, the first cap 1084a may be attached, via a first connecting portion 1086a, to the first longitudinal end 427 of the bottom rail 428 of the shutter curtain 120 and the second cap 1084b may be attached, via a second connecting portion 1086b, to the second longitudinal end 429 of the bottom rail 428 of the shutter curtain 120.

According to various embodiments, the second cord end 153 of the respective first inner cord 754a and first outer cord 754b may be threaded through the first connecting portion 1086a. According to various embodiments, the second cord end 153 of the respective second inner cord 756a and second outer cord 756b may be threaded through the second connecting portion 1086b. According to various embodiments, the stopper element 155 of the second cord end 153 of the respective cords 754a, 754b, 756a, 756b may be configured to retain or confine the respective first and second connecting portions 1086a, 1086b within the length of the respective cords 754a, 754b, 756a, 756b. According to various embodiments, the stopper element 155 of the second cord end 153 of the respective cords 754a, 754b, 756a, 756b may serve as a physical barrier to restrain or restrict or obstruct the respective first and second connecting portions 1086a, 1086b from sliding out from the second cord end 153 of the respective cords 754a, 754b, 756a, 756b. With the second cord end 153 of the respective cords 754a, 754b, 756a, 756b being coupled to the bottom rail 428 and the first and second cap 1084a, 1084b via the respective first and second connecting portion 1086a, 1086b, the second cord end 153 of the respective cords 754a, 754b, 756a, 756b may be restrained by the retaining arrangement 480 from sideways or lateral movements due to the bottom rail 428 being restrained or retained by the retaining arrangement 1080 when the shutter curtain 120 is lowered. According to various embodiments, with the four cords 754a, 754b, 756a, 756b extending from the rotatable drum 110 to the bottom rail 428, all the slats 130 of the shutter curtain 120 (including the bottom rail 428) may be confined within the length of the respective cords 754a, 754b, 756a, 756b. Accordingly, when the shutter curtain 120 is lowered, the shutter curtain 120 may weigh down the second cord end 153 of the respective cords 754a, 754b, 756a, 756b to the ground. Hence, the respective cords 754a, 754b, 756a, 756b may be extending from the rotatable drum 110 to the ground such that the respective cords 754a, 754b, 756a, 756b may provide additional support to the shutter curtain 120 in a manner so as to mitigate impact force applied on the shutter curtain 120.

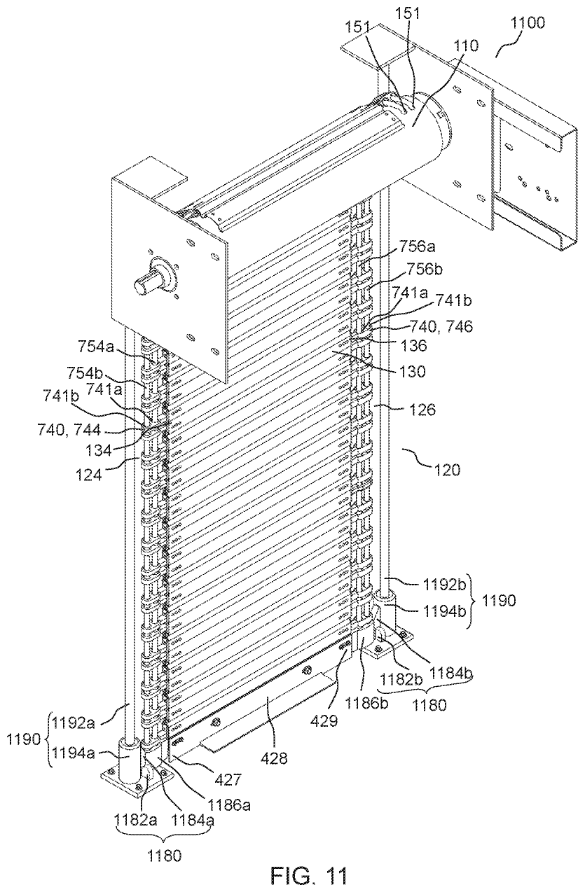

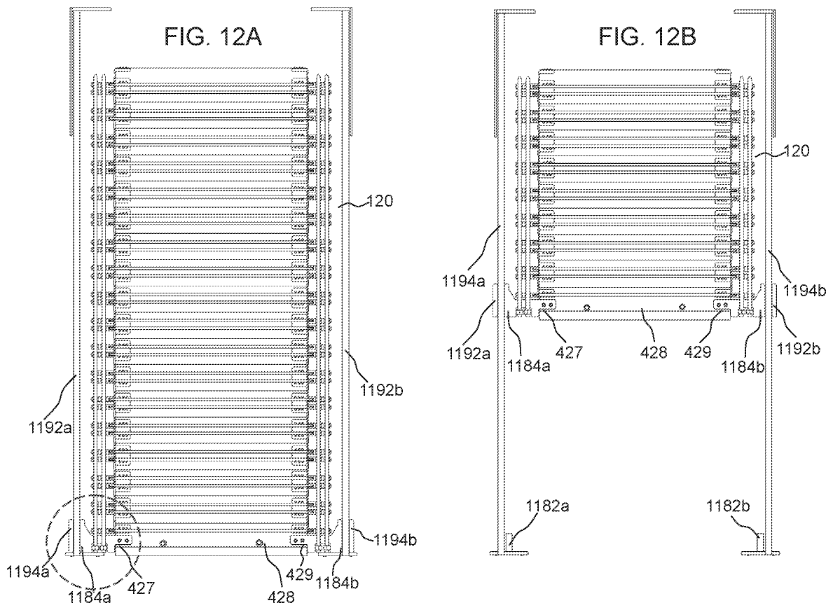

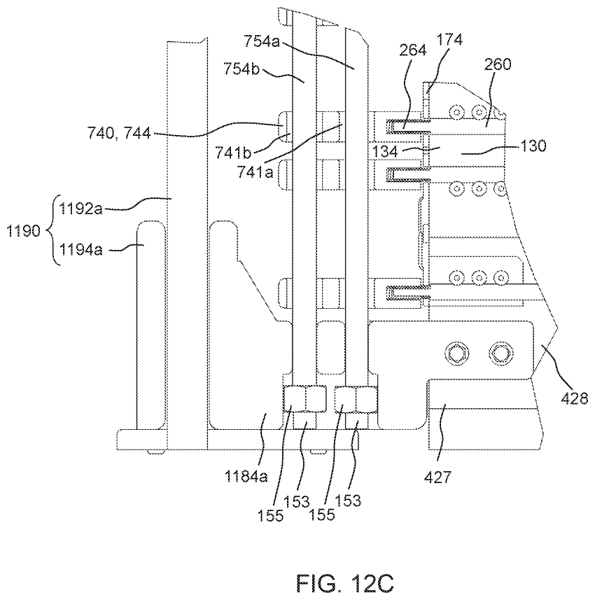

FIG. 11 shows a roller shutter 1100 according to various embodiments. FIG. 12A shows a cross sectional view of the shutter curtain 120 of the roller shutter 1100 of FIG. 11 when the shutter curtain 120 is fully lowered according to various embodiments. FIG. 12B shows a shows a cross sectional view of the shutter curtain 120 of the roller shutter 1100 of FIG. 12A when the shutter curtain 120 is partially lowered according to various embodiments. FIG. 12C shows an enlarged view of the circled portion in FIG. 12A illustrating a retaining arrangement 1180 according to various embodiments. According to various embodiments, the roller shutter 1100 of FIG. 11 may, similar to the roller shutter 100 of FIG. 1, the roller shutter 500 of FIG. 5, and the roller shutter 700 of FIG. 7, be configured for mitigating an impact force applied to the roller shutter 1100. According to various embodiments, the roller shutter 1100 of FIG. 11 may be similar to the roller shutter 700 of FIG. 7 in all aspect, except that the roller shutter 1100 of FIG. 11 may include the retaining arrangement 1180 (or the retaining-and-alignment arrangement) which is different from the retaining arrangement 1080 of the roller shutter 700 as shown in FIG. 10A to FIG. 10C and that the roller shutter 1100 of FIG. 11 may further include a sliding guide arrangement 1190. According to various embodiments, the roller shutter 1100 of FIG. 11 may, similar to the roller shutter 700 of FIG. 7, include, inter alia, the rotatable drum 110; the shutter curtain 120 having the series of three or more elongate slats 130; the first row 744 of double-eyelets-structures 740 and the second row 746 of double-eyelets-structures 740 formed along the first and second side borders 124, 126, respectively, of the shutter curtain 120; the at least one elongate reinforcing member 260, 360a, 360b extending within each elongate slat 130; and the first longitudinal end cover 174 and the second longitudinal end cover 176 coupled to each elongate slat 130.

According to various embodiments, the roller shutter 1100 may include the retaining arrangement 1180 (or the retaining-and-alignment arrangement). According to various embodiments, the retaining arrangement 1180 may, similar to the retaining arrangement 1080 of FIG. 10A to FIG. 10C, be configured to align a bottom rail 428 of the shutter curtain 120 to a predetermined position on a ground and to retain or restrain the bottom rail 428 from sideways or lateral movements in said position when the shutter curtain 120 is lowered. According to various embodiments, the retaining arrangement 1180 may, similar to the retaining arrangement 1080 of FIG. 10A to FIG. 10C, be configured such that the bottom rail 428 of the shutter curtain 120 may be brought into alignment with the predetermined position on the ground as the shutter curtain 120 is being lowered. Further, the retaining arrangement 1180 may, similar to the retaining arrangement 1080 of FIG. 10A to FIG. 10C, be configured such that the bottom rail 428 may not be easily moved out of alignment (or moved sideways or moved laterally) once the shutter curtain 120 is fully lowered. Accordingly, the retaining arrangement 1180 may be configured for laterally retaining the bottom rail 428 against sideways, or horizontal, or lateral movements.

According to various embodiments, the alignment arrangement 1180 may differ from the alignment arrangement 1080 of FIG. 10A to FIG. 10C, in that the retaining arrangement 1180 may include two brackets 1182a, 1182b, each bracket 1182a, 1182b having a Y-shaped slot, fixed to the ground and two corresponding insert members 1184a, 1184b attached to the bottom rail 428 of the shutter curtain 120. According to various embodiments, as the two corresponding insert members 1184a, 1184b fit into the two brackets 1182a, 1182b when the shutter curtain 120 is lowering, the bottom rail 428 of the shutter curtain 120 may be adjusted according to a straight line joining the two brackets 1182a, 1182b. According to various embodiments, the two brackets 1182a, 1182b may be fixed to the ground in a spaced apart manner such that, when the shutter curtain 120 is lowered, a first bracket 1182a may be adjacent a first longitudinal end 427 of the bottom rail 428 of the shutter curtain 120 and a second bracket 1182b may be adjacent to a second longitudinal end 429 of the bottom rail 428 of the shutter curtain 120. Accordingly, a first insert members 1184a may be attached, via a first connecting portion 1186a, to the first longitudinal end 427 of the bottom rail 428 of the shutter curtain 120 and a second insert member 1184b may be attached, via a second connecting portion 1186b, to the second longitudinal end 429 of the bottom rail 428 of the shutter curtain 120.

According to various embodiments, the second cord end 153 of the respective first inner cord 754a and first outer cord 754b may be threaded through the first connecting portion 1186a. According to various embodiments, the second cord end 153 of the respective second inner cord 756a and second outer cord 756b may be threaded through the second connecting portion 1186b. According to various embodiments, the stopper element 155 of the second cord end 153 of the respective cords 754a, 754b, 756a, 756b may be configured to retain or confine the respective first and second connecting portions 1186a, 1186b within the length of the respective cords 754a, 754b, 756a, 756b. According to various embodiments, the stopper element 155 of the second cord end 153 of the respective cords 754a, 754b, 756a, 756b may serve as a physical barrier to restrain or restrict or obstruct the respective first and second connecting portions 1186a, 1186b from sliding out from the second cord end 153 of the respective cords 754a, 754b, 756a, 756b. With the second cord end 153 of the respective cords 754a, 754b, 756a, 756b being coupled to the bottom rail 428 and the first and second insert members 1184a, 1184b via the respective first and second connecting portion 1186a, 1186b, the second cord end 153 of the respective cords 754a, 754b, 756a, 756b may be restrained by the retaining arrangement 1180 from sideways or lateral movements due to the bottom rail 428 being restrained or retained by the retaining arrangement 1180 when the shutter curtain 120 is lowered. According to various embodiments, with the four cords 754a, 754b, 756a, 756b extending from the rotatable drum 110 to the bottom rail 428, all the slats 130 of the shutter curtain 120 (including the bottom rail 428) may be confined within the length of the respective cords 754a, 754b, 756a, 756b. Accordingly, when the shutter curtain 120 is lowered, the shutter curtain 120 may weigh down the second cord end 153 of the respective cords 754a, 754b, 756a, 756b to the ground. Hence, the respective cords 754a, 754b, 756a, 756b may be extending from the rotatable drum 110 to the ground such that the respective cords 754a, 754b, 756a, 756b may provide additional support to the shutter curtain 120 in a manner so as to mitigate impact force applied on the shutter curtain 120.

According to various embodiments, the roller shutter 1100 may further include a sliding guide arrangement 1190 which may include a first guiding rod 1192a and a second guiding rod 1192b fixed to the ground in an upright orientation and spaced apart in a manner so as to be respectively disposed adjacent the first and second side borders 124, 126, respectively, of the shutter curtain 120 when the shutter curtain 120 is lowered. Accordingly, the first guiding rod 1192a and the second guiding rod 1192b may be erected from the ground upwards and set apart from each other by a distance equivalent or close to a width of the shutter curtain 120 measured from the first side border 124 to the second side border 126. According to various embodiments, the sliding guide arrangement 1190 may further include a first sliding element 1194a and a second sliding element 1194b attached to the first longitudinal end 427 and the second longitudinal end 429, respectively, of the bottom rail 428 of the shutter curtain 120. Accordingly, the first sliding element 1194a may be protruding from the first longitudinal end 427 of the bottom rail 428 of the shutter curtain 120 and the second sliding element 1194b may be protruding from the second longitudinal end 429 of the bottom rail 428 of the shutter curtain 120. According to various embodiments, the first sliding element 1194a may attached to the first longitudinal end 427 of the bottom rail 428 via the first insert member 1184a and the first connecting portion 1186a, and the second sliding element 1194b may be attached to the second longitudinal end 429 of the bottom rail 428 via the second insert member 1184b and the second connecting portion 1186b. According to various embodiments, the first sliding element 1194a may be in engagement with the first guiding rod 1192a and the second sliding element 1194b is in engagement with the second guiding rod 1192b. According to various embodiments, each of the first and second sliding elements 1194a, 1194b may be of a hollow cylindrical shape having a central through-hole whereby the first guiding rod 1192a is passed through the central through-hole of the first sliding element 1194a and the second guiding rod 1192b is passed through the central through-hole of the second sliding element 1194b such that each of the first and second sliding elements 1194a, 1194b may slide along respective first and second guiding rod 1192a, 1192b.

While the various embodiments as described and as shown in the drawings include eyelet-structure with either one eyehole (single-eyelet-structure) or two eyehole (i.e. double-eyelets-structure), it is understood that the eyelet-structure of the roller shutter according to various embodiments may include any number of eyeholes, for example one eyehole or two eyeholes or three eyeholes or more. Accordingly, the roller shutter may also include a corresponding number of cords for threading through the respective number of eyeholes in the manner as described earlier.

The following examples pertain to various embodiments.

Example 1 is a roller shutter including:
a rotatable drum having a rotational axis;
a shutter curtain including
   a series of three or more elongate slats pivotally interlocked in a longitudinal-edge-to-longitudinal-edge arrangement one after another and arranged parallel to the rotational axis of the rotatable drum in a manner so as to be capable of being wound on and off the rotatable drum together in an interlocked state, each of the elongate slats having a first longitudinal end portion and a second longitudinal end portion, wherein the first and second longitudinal end portions being respectively aligned to form a first side border and a second side border, respectively, of the shutter curtain, and wherein the first longitudinal end portion and the second longitudinal end portion of each elongate slat are respectively provided with at least one eyelet-structure which protrudes therefrom, whereby a first row of eyelet-structures and a second row of eyelet-structures are formed along the first and second side borders, respectively, of the shutter curtain; and
at least a first cord and a second cord, the first cord being strung loosely through all eyelet-structures of the first row of eyelet-structures and the second cord being strung loosely through all eyelet-structures of the second row of eyelet-structures, and each cord being configured to confine all eyelet-structures of respective row of eyelet-structures within a length of each cord.

In Example 2, the subject matter of Example 1 may optionally include that each cord may include a first cord end fixedly coupled to the rotatable drum and a second cord end having a stopper element which is configured to prevent the second cord end of said cord from sliding out of the respective row of eyelet-structures.

In Example 3, the subject matter of Example 1 may optionally include that each cord may include a first cord end having a first stopper element which may be configured to prevent the first cord end of said cord from sliding out of the respective row of eyelet-structures, and a second cord end having a second stopper element which may be configured to prevent the second cord end of said cord from sliding out of the respective row of eyelet-structures.

In Example 4, the subject matter of Example 2 or Example 3 may optionally include that respective stopper element may include a crimp end, a cord end cap, a knotted end, a bulged end, or an expanded end.

In Example 5, the subject matter of any one of Examples 1 to 4 may optionally include that the at least one eyelet-structure of each longitudinal end portion of each elongate slat may be protruding in a longitudinal direction of said elongate slat, and wherein the at least one eyelet-structure may be oriented with an axis of a hole of the at least one eyelet-structure of each longitudinal end portion of each elongate slat in a direction parallel to a breadth of said elongate slat.

In Example 6, the subject matter of any one of Examples 1 to 5 may optionally include that each of the elongate slats may include two eyelet-structures protruding from each longitudinal end portion of said elongate slat.

In Example 7, the subject matter of any one of Examples 1 to 6 may optionally include a plurality of elongate reinforcing members, each of the elongate slats including at least one elongate reinforcing member extending within said elongate slat in a manner so as to be aligned longitudinally to said elongate slat.

In Example 8, the subject matter of Example 7 may optionally include that the at least one elongate reinforcing member of at least one elongate slat may extend across an entire length of said elongate slat.

In Example 9, the subject matter of Example 8 may optionally include that the at least one eyelet-structure of each longitudinal end portion of the at least one elongate slat may be integral with the at least one reinforcing member extending within the at least one elongate slat.

In Example 10, the subject matter of Example 7 may optionally include that the at least one elongate slat may include a first elongate reinforcing member and a second elongate reinforcing member, wherein the first elongate reinforcing member may extend longitudinally inwards from the first longitudinal end portion of the at least one elongate slat for more than a tenth, or a fifth, or a quarter of a length of the at least one elongate slat and the second elongate reinforcing member may extend longitudinally inwards from the second longitudinal end portion of the at least one elongate slat for more than a tenth, or a fifth, or a quarter of a length of the at least one elongate slat.

In Example 11, the subject matter of Example 10 may optionally include that the at least one eyelet-structure of the first longitudinal end portion of the at least one elongate slat may be integral with the first elongate reinforcing member, and the at least one eyelet-structure of the second longitudinal end portion of the at least one elongate slat may be integral with the second elongate reinforcing member.

In Example 12, the subject matter of any one of Examples 1 to 11 may optionally include a retaining arrangement configured to align a bottom rail of the shutter curtain to a predetermined position on a ground and to retain or restrain the bottom rail from sideways or lateral movements in said position when the shutter curtain is lowered.

In Example 13, the subject matter of Example 12 may optionally include that the retaining arrangement may include two bollards fixed to the ground and two corresponding caps attached to the bottom rail of the shutter curtain.

In Example 14, the subject matter of Example 12 may optionally include that the retaining arrangement may include two brackets, each bracket having a Y-shaped slot, fixed to the ground and two corresponding insert members attached to the bottom rail of the shutter curtain.

In Example 15, the subject matter of any one of Examples 12 to 14 may optionally include a sliding guide arrangement which may include a first guiding rod and a second guiding rod fixed to the ground in an upright orientation and spaced apart in a manner so as to be respectively disposed adjacent the first and second side borders, respectively, of the shutter curtain when the shutter curtain is lowered, and a first sliding element and a second sliding element attached to a first longitudinal end and a second longitudinal end, respectively, of the bottom rail of the shutter curtain, wherein the first sliding element is in engagement with the first guiding rod and the second sliding element is in engagement with the second guiding rod.

In Example 16, the subject matter of any one of Examples 1 to 15 may optionally include that each eyelet-structure may include or may be a double-eyelets-structure such that the first row of eyelet-structures may form a first row of double-eyelets-structures and the second row of eyelet-structures may form a second row of double-eyelets-structures, wherein the roller shutter may further include a third cord and a fourth cord, and wherein the first cord may be strung loosely through all inner eyeholes of the double-eyelets-structures of the first row of double-eyelets-structures, the second cord may be strung loosely through all inner eyeholes of the double-eyelets-structures of the second row of eyelet-structures, the third cord may be strung loosely through all outer eyeholes of the double-eyelets-structures of the first row of double-eyelets-structures, and the fourth cord may be strung loosely through all outer eyeholes of the double-eyelets-structures of the second row of double-eyelets-structures.

Various embodiments have provided a roller shutter that may be effective in mitigating a sudden impact force, whereby risk of broken or fractured slats being dislodged from the shutter curtain be minimized or eliminated. Accordingly, the roller shutter of the various embodiments may be used in area where there is high explosion or blast risk.

While the invention has been particularly shown and described with reference to specific embodiments, it should be understood by those skilled in the art that various changes, modification, variation in form and detail may be made therein without departing from the scope of the invention as defined by the appended claims. The scope of the invention is thus indicated by the appended claims and all changes which come within the meaning and range of equivalency of the claims are therefore intended to be embraced.

1. A roller shutter comprising
a rotatable drum having a rotational axis;
a shutter curtain comprising
a series of three or more elongate slats pivotally interlocked in a longitudinal-edge-to-longitudinal-edge arrangement one after another and arranged parallel to the rotational axis of the rotatable drum in a manner so as to be capable of being wound on and off the rotatable drum together in an interlocked state, each of the elongate slats having a first longitudinal end portion and a second longitudinal end portion, wherein the first and second longitudinal end portions being respectively aligned to form a first side border and a second side border, respectively, of the shutter curtain, and wherein the first longitudinal end portion and the second longitudinal end portion of each elongate slat are respectively provided with at least one eyelet-structure which protrudes therefrom, whereby a first row of eyelet-structures and a second row of eyelet-structures are formed along the first and second side borders, respectively, of the shutter curtain; and
at least a first cord and a second cord, the first cord being strung loosely through all eyelet-structures of the first row of eyelet-structures and the second cord being strung loosely through all eyelet-structures of the second row of eyelet-structures, and each cord being configured to confine all eyelet-structures of respective row of eyelet-structures within a length of each cord,
wherein each of the elongate slats comprises at least one elongate reinforcing member extending within said elongate slat in a manner so as to be aligned longitudinally to said elongate slat, wherein the at least one elongate reinforcing member extends across an entire length of said elongate slat, and wherein the at least one eyelet-structure of the first longitudinal end portion of said elongate slat is integrally connected to a first longitudinal end of the at least one reinforcing member and the at least one eyelet-structure of the second longitudinal end portion of said elongate slat is integrally connected to a second longitudinal end of the at least one reinforcing member.

2. The roller shutter as claimed in claim 1, wherein each cord comprises a first cord end fixedly coupled to the rotatable drum and a second cord end having a stopper element which is configured to prevent the second cord end of said cord from sliding out of the respective row of eyelet-structures.

3. The roller shutter as claimed in claim 1, wherein each cord comprises a first cord end having a first stopper element which is configured to prevent the first cord end of said cord from sliding out of the respective row of eyelet-structures, and a second cord end having a second stopper element which is configured to prevent the second cord end of said cord from sliding out of the respective row of eyelet-structures.

4. The roller shutter as claimed in claim 2, wherein respective stopper element comprises a crimp end, a cord end cap, a knotted end, a bulged end, or an expanded end.

5. The roller shutter as claimed in claim 1, wherein the at least one eyelet-structure of each longitudinal end portion of each elongate slat is protruding in a longitudinal direction of said elongate slat, and wherein the at least one eyelet-structure is oriented with an axis of a hole of the at least one eyelet-structure of each longitudinal end portion of each elongate slat in a direction parallel to a breadth of said elongate slat.

6. The roller shutter as claimed in claim 1, wherein each of the elongate slats comprises two eyelet-structures protruding from each longitudinal end portion of said elongate slat.

7. The roller shutter as claimed in claim 1, further comprising a retaining arrangement configured to align a bottom rail of the shutter curtain to a predetermined position on a ground and to restrain the bottom rail from sideways or lateral movements in said position when the shutter curtain is lowered.

8. The roller shutter as claimed in claim 7, wherein the retaining arrangement comprises two bollards fixed to the ground and two corresponding caps attached to the bottom rail of the shutter curtain.

9. The roller shutter as claimed in claim 7, wherein the retaining arrangement comprises two brackets, each bracket having a Y-shaped slot, fixed to the ground and two corresponding insert members attached to the bottom rail of the shutter curtain.

10. The roller shutter as claimed in claim 8, further comprising a sliding guide arrangement which comprises a first guiding rod and a second guiding rod fixed to the ground in an upright orientation and spaced apart in a manner so as to be respectively disposed adjacent the first and second side borders, respectively, of the shutter curtain when the shutter curtain is lowered, and a first sliding element and a second sliding element attached to a first longitudinal end and a second longitudinal end, respectively, of the bottom rail of the shutter curtain, wherein the first sliding element is in engagement with the first guiding rod and the second sliding element is in engagement with the second guiding rod.

11. The roller shutter as claimed in claim 1,
wherein each eyelet-structure comprises a double-eyelets-structure such that the first row of eyelet-structures forms a first row of double-eyelets-structures and the second row of eyelet-structures forms a second row of double-eyelets-structures,
wherein the roller shutter further comprises a third cord and a fourth cord, and
wherein the first cord is strung loosely through all inner eyeholes of the double-eyelets-structures of the first row of double-eyelets-structures, the second cord is strung loosely through all inner eyeholes of the double-eyelets-structures of the second row of eyelet-structures, the third cord is strung loosely through all outer eyeholes of the double-eyelets-structures of the first row of double-eyelets-structures, and the fourth cord is strung loosely through all outer eyeholes of the double-eyelets-structures of the second row of double-eyelets-structures.

12. The roller shutter as claimed in claim 9, further comprising a sliding guide arrangement which comprises a first guiding rod and a second guiding rod fixed to the ground in an upright orientation and spaced apart in a manner so as to be respectively disposed adjacent the first and second side borders, respectively, of the shutter curtain when the shutter curtain is lowered, and a first sliding element and a second sliding element attached to a first longitudinal end and a second longitudinal end, respectively, of the bottom rail of the shutter curtain, wherein the first sliding element is in engagement with the first guiding rod and the second sliding element is in engagement with the second guiding rod.

13. The roller shutter as claimed in claim 1, wherein each of the elongate slats comprises a first longitudinal end cover fixedly coupled to the first longitudinal end portion and a second longitudinal end cover fixedly coupled to the second longitudinal end portion.

14. The roller shutter as claimed in claim 13, wherein each of the first longitudinal end cover and the second longitudinal end cover comprises at least one hole through which the at least one elongate reinforcing member is inserted so as to be extending across the entire length of said elongate slat.

15. The roller shutter as claimed in claim 6, wherein each of the elongate slats comprises two elongate reinforcing members, each elongate reinforcing members extending across the entire length of said elongate slat.

16. The roller shutter as claimed in claim 15, wherein each of the elongate slats comprises a first longitudinal end cover fixedly coupled to the first longitudinal end portion and a second longitudinal end cover fixedly coupled to the second longitudinal end portion.

17. The roller shutter as claimed in claim 16, wherein each of the first longitudinal end cover and the second longitudinal end cover comprises two holes through which the two reinforcing member are respectively inserted so as to be extending across the entire length of said elongate slat.

18. The roller shutter as claimed in claim 7, wherein each of the first cord and the second cord extends from the rotatable drum to the bottom rail of the shutter curtain in a manner so as to confine the series of three or more elongate slats within the length of each cord.

19. The roller shutter as claimed in claim 8, wherein each of the two bollards has a height higher than a height of the bottom rail of the shutter curtain.

20. The roller shutter as claimed in claim 9, wherein the two corresponding insert members are configured to be fitted into the Y-shaped slots of the two brackets respectively when the shutter curtain is lowered.
